(19) United States
(12) Patent Application Publication
(10) Pub. No.: US 2026/0279635 A1
(43) Pub. Date: Sep. 17, 2026

(54) Methods and Systems for Operating Superconducting Magnetic Energy Storage Devices

(71) Applicants: KING FAHD UNIVERSITY OF PETROLEUM AND MINERALS, Dhahran (SA); BRUNEL UNIVERSITY OF LONDON, Uxbridge, Middlesex (GB)

(72) Inventors: Mujahed Mohammad AL-DHAIFALLAH, Dhahran (SA); Shady Hossam Eldeen Abdel Aleem ELSEBAEEY, Cairo (EG); Martin CALASAN, Podgorica (ME); Ziad Mohammed Mohammed ALI, Aswan (EG); Ahmed Faheem ZOBAA, London (GB); Hany Mohamed Hasanien MOHAMED, Cairo (EG)

(73) Assignees: KING FAHD UNIVERSITY OF PETROLEUM AND MINERALS, Dhahran (SA); BRUNEL UNIVERSITY OFLONDON, Uxbridge, Middlesex (GB)

(21) Appl. No.: 19/006,710

(22) Filed: Dec. 31, 2024

(51) Int. Cl. H01F 6/00; H01F 6/04; H01F 6/06

(52) U.S. Cl. CPC H01F 6/008; H01F 6/04; H01F 6/06

(57) ABSTRACT

Methods and systems for controlling charging and discharging of a superconducting magnetic energy storage (SMES) device include a control system configured to derive transcendental equations for a voltage across superconducting coil of the SMES device and DC current stored in magnetic field of superconducting coil. The control system is configured to solve transcendental equations to predict the voltage across the superconducting coil and the DC current stored in the magnetic field using Perovich special trans function theory and Lambert's W equation. The control system actuates selectable switches based on the predicted voltage and DC current to perform one of charging the superconducting coil with the DC current and storing the DC current in the magnetic field and discharging the superconducting coil to generate a discharge DC current, converting the discharge DC current to AC power, and transmitting the AC power to a three phase power system.

### BACKGROUND

### Technical Field

The present disclosure is directed to methods and systems for investigating electric performance of superconducting magnetic energy storage (SMES) devices.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Superconducting Magnetic Energy Storage (SMES) systems represent cutting-edge technology for storing electrical energy within magnetic fields created by superconducting currents. These systems provide several critical advantages, including exceptionally high energy efficiency, rapid response times, and extended operational lifespans. These features make SMES systems particularly suitable for applications requiring high power density and reliability. However, the modeling and optimization of SMES systems for constant power applications remain underexplored. One primary challenge lies in the nonlinear and complex differential equations governing SMES system behavior. This complexity makes it difficult to accurately predict their performance, particularly concerning thermal dynamics under variable operating conditions.

Conventionally, research has concentrated on modeling the charging and discharging processes of supercapacitors (SCs), which exhibit some operational parallels to SMES systems. Traditional approaches often rely on equivalent circuit models to analyze thermal processes in SCs during constant power operation. These models provide valuable insights into temperature variations and help optimize performance. However, due to the unique physical attributes of SMES systems, such as the reliance on superconducting materials and the storage of energy in magnetic fields, analogous models for SMES have not been effectively developed or applied.

For instance, CN102377362A introduces a mathematical model for a voltage source SMES converter within a synchronous rotating coordinate system. This approach decouples control parameters for the high-temperature superconducting energy storage system converter topology using the equivalent circuit principle. It also establishes a four-quadrant, three-phase, fully controlled voltage source converter (VSC) mathematical model. While useful, this reference does not address predicting the direct current (DC) or the voltage across the superconducting coil of an SMES device.

Similarly, U.S. Pat. No. 8,933,572B1 describes an adaptive control method and system for SMES. This system leverages a radial basis function neural network (RBFNN) integrated with the SMES controller to dynamically adjust the controller's gain constants. Despite its adaptability, this approach does not predict the voltage across the superconducting coil or the DC current based on an equivalent circuit model. Moreover, it does not consider the charging and discharging processes of an SMES device in light of these predicted values.

These limitations underscore the need for more comprehensive methodologies that address the unique challenges of SMES systems. Existing models fall short in practical industrial and modern energy applications, particularly when managing the charging and discharging cycles of SMES devices.

To address these gaps, this disclosure presents a novel method and system for controlling the charging and discharging processes of SMES devices. This approach involves solving an equivalent circuit model of a superconducting coil using Perovich's special transfer function theory. By employing this advanced mathematical framework, accurate predictions of the DC current and voltage across the superconducting coil can be made. These predictions form the basis for controlling the charging and discharging processes of SMES systems, unlocking new potentials for their application in industrial power systems and cutting-edge energy solutions.

### SUMMARY

In an exemplary embodiment, a method for controlling charging and discharging of a superconducting magnetic energy storage (SMES) device includes connecting a three phase input terminal of a power conditioning system to a three phase power system, wherein the power conditioning system includes an AC/DC converter and a plurality of selectable switches. The method further includes connecting an input terminal and an output terminal of a superconducting coil of the SMES device to the power conditioning system, and receiving, by the SMES device, a DC current from the power conditioning system, where the SMES device includes a magnet surrounded by the superconducting coil, wherein the superconducting coil is configured to store the DC current in a magnetic field of the superconducting coil. The method further includes connecting a cryogenic refrigeration system to the SMES device and connecting a control system to the power conditioning system, the cryogenic refrigeration system and the SMES device. The control system includes a memory storing an equivalent circuit model of the SMES device and program instructions including a Perovich special trans function and Lambert's W equation, and at least one processor configured for executing the program instructions for deriving, by the control system, a set of transcendental equations for a voltage across the superconducting coil and the DC current stored in the magnetic field of the superconducting coil based on the equivalent circuit model, solving, by the at least one processor, the set of transcendental equations to predict a voltage V_{L} across the superconducting coil and the DC current I_{L} stored in the magnetic field of the superconducting coil using the Perovich special trans function theory and Lambert's W equation, actuating, by the control system, the plurality of selectable switches based on the predicted voltage and the predicted DC current to perform one of: charging the superconducting coil with the DC current and storing the DC current in the magnetic field of the superconducting coil; and discharging the superconducting coil to generate a discharge DC current, converting the discharge DC current to AC power in the power conditioning system, and transmitting the AC power to the three phase power system.

In another exemplary embodiment, a system for controlling charge and discharge cycles of a superconducting magnetic energy storage (SMES) device includes a three phase power system, a power conditioning system configured with a set of three phase input terminals, where the set of three phase input terminals are connected by a transformer to a set of three phase output terminals of the three phase power system, a superconducting magnetic energy storage (SMES) device operatively connected to the power conditioning system, wherein the SMES device includes a superconducting coil, a cryogenic refrigeration system operatively connected to the SMES device, and a control system connected to the power conditioning system, the cryogenic refrigeration system and the SMES. The control system includes a memory storing an equivalent circuit model of the SMES and program instructions including a Perovich special trans function and Lambert's W equation, and at least one processor configured for executing the program instructions to derive a set of transcendental equations for a voltage across the superconducting coil and a DC current stored in the magnetic field of the superconducting coil based on the equivalent circuit model, predict a voltage V_{L} across the superconducting coil and the DC current I_{L} stored in the magnetic field of the superconducting coil by solving the set of transcendental equations to using the Perovich special trans function theory and Lambert's W equation, actuate the power conditioning system based on the predicted voltage and the predicted DC current to perform one of: charge the superconducting coil with the DC current and storing the DC current in the magnetic field of the superconducting coil; and discharge the superconducting coil to generate a discharge DC current, convert the discharge DC current to AC power in the power conditioning system, and transmit the AC power to the three phase power system.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a system for controlling charge and discharge cycles of a superconducting magnetic energy storage (SMES) device, according to certain embodiments.

FIG. 1B illustrates an electric circuit diagram of the system, according to certain embodiments.

FIG. 2 illustrates a circuit design of a power conditioning system, according to certain embodiments.

FIG. 3 illustrates a cryogenic refrigeration system, according to certain embodiments.

FIG. 4A illustrates a series circuit model of the SMES device, according to certain embodiments.

FIG. 4B illustrates a parallel circuit model of the SMES device, according to certain embodiments.

FIG. 5A illustrates a graph depicting dependency of a current of the SMES device as a function of transcendental equation, according to certain embodiment.

FIG. 5B illustrates a graph depicting dependency of the current of the SMES device as another function of transcendental equation, according to certain embodiments.

FIG. 6A illustrates a graph representing values of charging and discharging currents for series model based SMES device 500 kilowatt (kW) and 1 megawatt (MW), according to certain embodiments.

FIG. 6B illustrates a graph representing values of charging and discharging voltages for series model based SMES device at power values of 500 kW and 1 MW, according to certain embodiments.

FIG. 7A illustrates a three-dimensional (3D) visualization of change in current as a function of time during discharging for different resistance values for series model based SMES device, according to certain embodiments.

FIG. 7B illustrates a 3D visualization of change in voltage as a function of time during discharging for different resistance values for the series model based SMES device, according to certain embodiments.

FIG. 8A illustrates a 3D visualization of change in current as a function of time during charging for different resistance values for the series model based SMES device, according to certain embodiments.

FIG. 8B illustrates a 3D visualization of change in voltage as a function of time during charging for different resistance values for the series model based SMES device, according to certain embodiments.

FIG. 9A illustrates a graph representing values of charging and discharging currents for parallel model based SMES device at power values of 500 kW and 1 MW, according to certain embodiments.

FIG. 9B illustrates a graph representing values of charging and discharging voltages for parallel model based SMES device at power values of 500 kW and 1 MW, according to certain embodiments.

FIG. 10A illustrates the 3D visualization of change in current as a function of time during discharging for different resistance values for a parallel model based SMES device, according to certain embodiments.

FIG. 10B illustrates a 3D visualization of change in voltage as a function of time during discharging for different resistance values for the parallel model based SMES device, according to certain embodiments.

FIG. 11A illustrates a 3D visualization of change in current as a function of time during charging for different resistance values for the parallel model based SMES device, according to certain embodiments.

FIG. 11B illustrates a 3D visualization of change in voltage as a function of time during charging for different resistance values for the parallel model based SMES device, according to certain embodiments.

FIG. 12A illustrates a graph representing an impact of inductance on current during charging and discharging of the series model based SMES device at a power value of 500 kW with variable inductance and resistance of 0.1Ω, according to certain embodiments.

FIG. 12B illustrates a graph representing an impact of inductance on voltage during the charging and discharging of the series model based SMES device at power value of 500 kW with variable inductance and resistance of 0.1Ω, according to certain embodiments.

FIG. 13A illustrates a graph representing an impact of inductance on current during the charging and discharging of the parallel model based SMES device at power value of 500 kW with variable inductance and resistance of 50Ω, according to certain embodiments.

FIG. 13B illustrates a graph representing an impact of inductance on voltage during the charging and discharging of the parallel model based SMES device at power value of 500 kW with variable inductance and resistance of 50Ω, according to certain embodiments.

FIG. 14A illustrates a graph representing current changes for series and parallel parameter value combinations during discharge process at a power of 500 kW, according to certain embodiments.

FIG. 14B illustrates a graph representing voltage changes for series and parallel parameter value combinations during discharge process at a power of 500 kW, according to certain embodiments.

FIG. 15A illustrates a graph representing a power variation pattern for current and voltage change during charging for the series model based SMES device at R=0.1Ω, according to certain embodiments.

FIG. 15B illustrates a graph representing current change during charging for successive power variations for the series model based SMES device at R=0.1Ω, according to certain embodiments.

FIG. 15C illustrates a graph representing voltage change during charging for successive power variations for the series model based SMES device at R=0.1Ω, according to certain embodiments.

FIG. 16A illustrates a graph representing a power variation pattern for current and voltage change during charging for the parallel model based SMES device at R=50Ω, according to certain embodiments.

FIG. 16B illustrates a graph representing current change during charging for successive power variations for the parallel model based SMES device at R=50Ω, according to certain embodiments.

FIG. 16C illustrates a graph representing voltage change during charging for successive power variations for the parallel model based SMES device at R=50Ω, according to certain embodiments.

FIG. 17 is an illustration of a non-limiting example of details of computing hardware used in the computing system, according to certain embodiments.

FIG. 18 is an exemplary schematic diagram of a data processing system used within the computing system, according to certain embodiments.

FIG. 19 is an exemplary schematic diagram of a processor used with the computing system, according to certain embodiments.

FIG. 20 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a method and system of controlling charging and discharging in a superconducting magnetic energy storage (SMES) device by connecting an input terminal of a power conditioning system to a three phase power system, where the power conditioning device includes an AC/DC converter, a DC/AC converter, and multiple selectable switches. An input terminal of a superconducting coil within the SMES device is connected to the power conditioning device. The SMES device includes a magnet surrounded by the superconducting coil, which is configured to convert DC current into a magnetic field, as well as a cryogenic refrigeration system that surrounds the superconducting coil and the magnet. An output terminal of the superconducting coil is connected to an input terminal of the power conditioning system. An output terminal of the power conditioning system is then connected to the three phase power system. The system predicts the voltage across the superconducting coil and the DC current within it by solving an equivalent circuit model of the superconducting coil using a Perovich special trans function theory and Lambert's W equation. Based on the predicted voltage and DC current, the system controls the selectable switches to either discharge the superconducting coil to generate DC current, convert the DC current to AC power, and transmit the AC power to the three phase power system, or charge the superconducting coil by converting AC power from the three phase power system to DC current and store the DC current within the magnetic field of the superconducting coil.

Advantages of the disclosed system include better management of the thermal behavior to realize the efficient operation of the SMES device and reduction of costs, potentially lowering SMES energy storage costs in energy storage markets. Additionally, the system can be implemented in different markets, such as electric utility projects due to its straightforward layout.

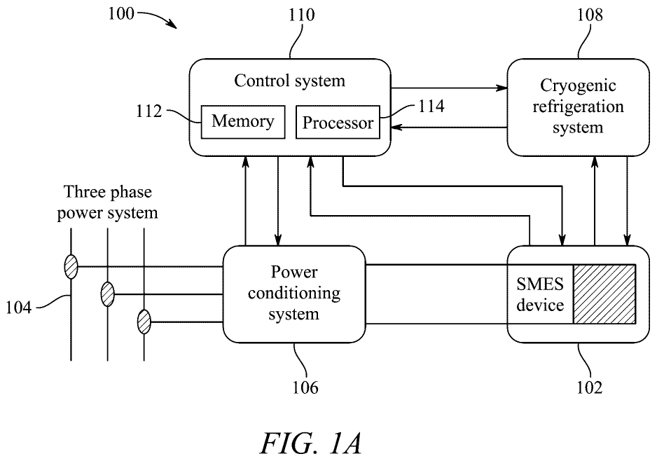

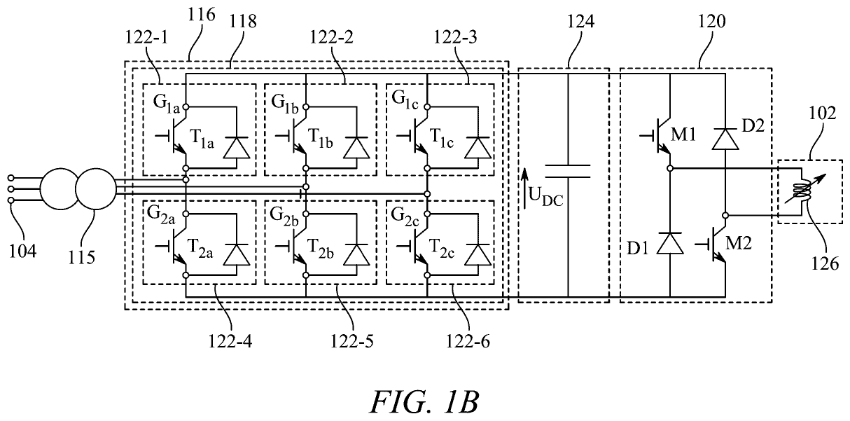

FIG. 1A illustrates a system 100 for controlling charge and discharge cycles of a superconducting magnetic energy storage (SMES) device 102.

The system 100 comprises the SMES device 102 (interchangeably referred to as SMES 102), a three phase power system 104 (interchangeably referred to as the AC utility grid 104), a power conditioning system 106 (interchangeably referred to as the power controller 106), a cryogenic refrigeration system 108, and a control system 110. The cryogenic refrigeration system 108 maintains the SMES device 102 at a cryogenic temperature necessary to cool the superconducting coil during operation. The SMES device 102 must be kept at or below the critical temperature in the range of 10° K to 20° K in order to operate with zero resistance. The cryogenic refrigeration system 108 includes liquid helium cooling coils. To ensure seamless operation, the cryogenic refrigeration system 108, along with the SMES device 102 and the power conditioning system 106, are integrated into a cohesive system that enables coordinated and precise management of all components.

FIG. 1A illustrates the connection between the SMES device 102 and the three phase power system 104, highlighting the flow of signals between the power conditioning system 106, the control system 110, and the SMES device 102. The power conditioning system 106 facilitates voltage adjustment for the SMES device 102. The power conditioning system 106 is responsible for aligning the voltages and currents of the SMES device 102 with the three phase power system 104 using power electronics.

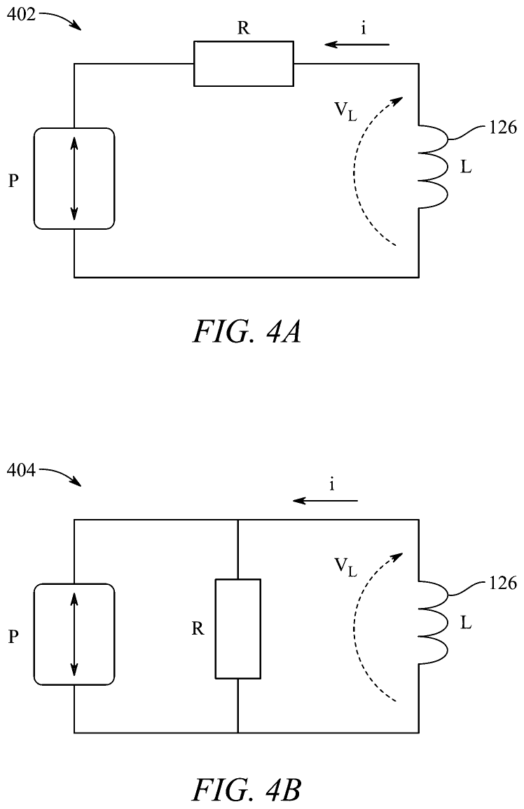

The power conditioning system 106 is configured with a set of three phase input terminals. The set of three phase input terminals are connected by a three phase transformer to a set of three phase output terminals of the three phase power system 104. The SMES device 102 is operatively connected to the power conditioning system 106. The SMES device 102 includes a superconducting coil. The cryogenic refrigeration system 108 is operatively connected to the SMES device 102. The control system 110 is connected to the power conditioning system 106, the cryogenic refrigeration system 108, and the SMES device 102. The control system 110 includes a memory 112 and at least one processor 114. The memory 112 stores an equivalent circuit model of the SMES device 102 and program instructions including a Perovich special trans function and Lambert's W equation. In an aspect, the equivalent circuit model of the SMES device 102 includes a series connection of the DC power input to a resistor R representing an internal resistance of the superconducting coil and an inductor L representing the superconducting coil, a DC current entering the resistor R and the voltage V_{L} across the inductor L, as shown in FIG. 4A. In another aspect, the equivalent circuit model of the SMES device 102 includes a parallel connection of the DC power input, a resistor R representing an internal resistance of the superconducting coil and an inductor L representing the superconducting coil, a DC current which exits the inductor L and a voltage V_{L} across the inductor L, as shown in FIG. 4B.

In an aspect, the at least one processor 114 of the control system 110 is configured to execute the program instructions to derive a set of transcendental equations for a voltage across the superconducting coil of the SMES device 102 and a DC current stored in magnetic field of the superconducting coil based on the equivalent circuit model. The at least one processor 114 is configured to execute the program instructions to predict a voltage V_{L} across the superconducting coil and the DC current I_{L} stored in the magnetic field of the superconducting coil by solving the set of transcendental equations using the Perovich special trans function theory and Lambert's W equation. The at least one processor 114 is further configured to execute the program instructions to actuate the power conditioning system 106 based on the predicted voltage and the predicted DC current to perform one of charging the superconducting coil with the DC current and storing the DC current in the magnetic field of the superconducting coil, and discharging the superconducting coil to generate a discharge DC current, converting the discharged DC current to AC power in the power conditioning system 106, and transmitting the AC power to the three phase power system 104.

FIG. 1B illustrates an electric circuit diagram of the system 100, as described with reference to FIG. 1A.

In an aspect, the power conditioning system 106 is configured with a set of three phase input terminals. The set of three phase input terminals are connected by a three phase transformer 115 (interchangeably referred to as transformer 115) to a set of three phase output terminals of the three phase power system 104. The power conditioning system 106 includes an AC/DC converter 116. The AC/DC converter 116 includes a voltage source converter 118. Further, the power conditioning system 106 includes a DC/DC converter 120. The voltage source converter 118 comprises a plurality of selectable switches 122-(1-6) connected to the set of three phase input terminals and a DC-link capacitor 124 (interchangeably referred to as capacitor 124) connected parallel to the voltage source converter 118. The DC/DC converter 120 is connected parallel to the voltage source converter 118 and the DC-link capacitor 124. The DC/DC converter 120 includes a set of DC output terminals configured to connect to the SMES device 102. Although six switches 122-(1-6) are shown in FIG. 1B for illustrative purposes, it will be understood that the number of switches may be any suitable number, depending on the specific application or configuration of the system 100. The present disclosure is not limited to the exact number of switches depicted, and additional or fewer switches may be employed without departing from the scope of the present disclosure.

In an aspect, the plurality of selectable switches 122-(1-6) includes three sets of series connected N-channel MOSFET transistors each having an antiparallel diode. A first set includes a first N-channel MOSFET transistor T₁ₐ having a drain terminal connected to a positive bus line, a gate terminal G₁ₐ, and a source terminal and a second N-channel MOSFET transistor T₂ₐ having a drain terminal connected to the source terminal of the first N-channel MOSFET transistor T₁ₐ, a gate terminal G₂ₐ and a source terminal connected to a negative bus line. The source terminal of the first N-channel MOSFET transistor T₁ₐ is connected to a first phase terminal Pₐ of the set of three phase input terminals. The second set includes a first N-channel MOSFET transistor T_{1b} having a drain terminal connected to the positive bus line, a gate terminal G_{1b} and a source terminal and a second N-channel MOSFET transistor T_{2b} having a drain terminal connected to the source terminal of the first N-channel MOSFET transistor T_{1b}, a gate terminal G_{2b} and a source terminal connected to the negative bus line. The source terminal of the first N-channel MOSFET transistor T_{1b} is connected to a second phase terminal P_{b} of the set of three phase input terminals. A third set includes a first N-channel MOSFET transistor T_{1c} having a drain terminal connected to the positive bus line, a gate terminal G_{1c}, and a source terminal and a second N-channel MOSFET transistor T_{2c} having a drain terminal connected to the source terminal of the first N-channel MOSFET transistor T_{1c}, a gate terminal G_{2c} and a source terminal connected to the negative bus line. The source terminal of the first N-channel MOSFET transistor T_{1c} is connected to a third phase terminal P_{c} of the set of three phase input terminals.

The DC-link capacitor 124 has a first terminal connected to the positive bus line and a second terminal connected to the negative bus line. The DC/DC converter 120 includes an N-channel MOSFET transistor M₁ having a drain terminal connected to the positive bus line, a gate terminal G_{M1}, and a source terminal connected to an input terminal of a superconducting coil 126 of the SMES device 102. The DC/DC converter 120 further includes a first reverse diode D₁ having an output terminal connected to the source terminal of the N-channel MOSFET transistor M₁ and an input terminal connected to the negative bus line. The DC/DC converter 120 also includes a second reverse diode D₂ having an output terminal to the positive bus line. The DC/DC converter 120 includes an N-channel MOSFET transistor M₂ having a source terminal connected to the negative bus line, a gate terminal G_{M2} and a drain terminal connected to an output terminal of the superconducting coil 126 of the SMES device 102.

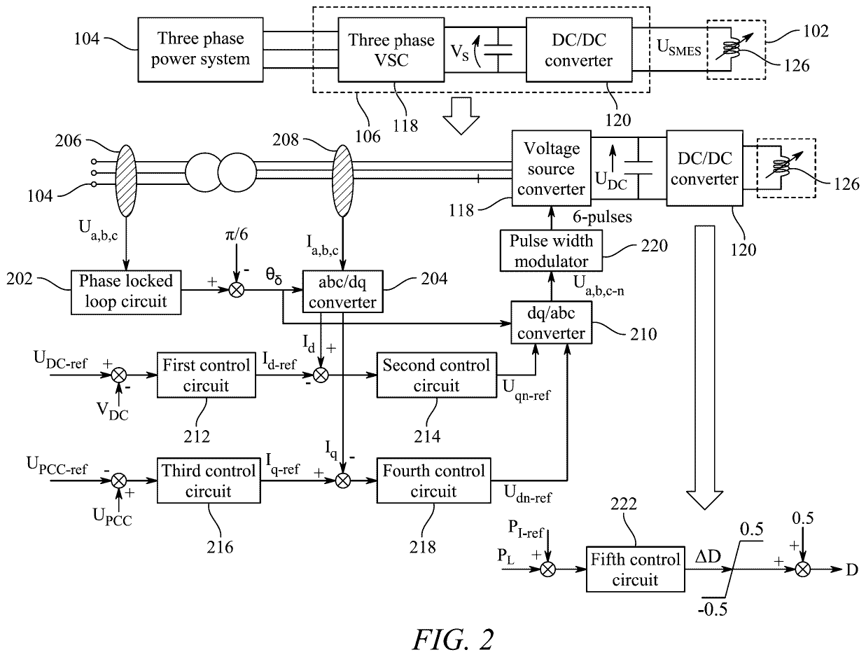

FIG. 2 illustrates a circuit design of the power conditioning system 106 of the system 100, as described with reference to FIG. 1A and FIG. 1B. The circuit diagram features configurations of the voltage source converter 118 and the DC/DC converter 120. The circuit operates without the inclusion of a battery.

The power conditioning system 106 includes a phase locked loop circuit 202 (interchangbly referred to as phase locked loop 202), an abc/dq converter 204 operatively connected to the phase locked loop circuit 202, a first transmission line meter 206, a second transmission line meter 208, a dq/abc converter 210, a first control circuit 212, a second control circuit 214, a third control circuit 216, a fourth control circuit 218, a pulse width modulator 220, and a fifth control circuit 222.

The first transmission line meter 206 is connected to a set of three phase transmission lines of the three phase power system 104. The first transmission line meter 206 is located on the set of three transmission lines between the three phase power system 104 and the transformer 115. The first transmission line meter 206 is configured to measure a voltage of each of the three phase transmission lines and transmit the measured voltages to the phase locked loop 202. The phase locked loop 202 is configured to generate a phase error of the measured voltages with respect to a reference phase angle.

The second transmission line meter 208 is connected to the three phase transmission lines located on the set of three transmission lines between the transformer 115 and the power conditioning system 106. The second transmission line meter 208 is configured to measure a current on each of the three phase transmission lines and a voltage on each of the three phase transmission lines. The second transmission line meter 208 is further configured to transmit the measured currents to the abc/dq converter 204. The dq/abc converter 210 is operatively connected to an output terminal of the phase locked loop circuit 202. The dq/abc converter 210 is configured to receive the phase error.

The first control circuit 212 is configured to receive the predicted voltage V_{L} from the control system 110 and generate a voltage error signal between a DC value of the predicted voltage V_{L} and a DC value of the measured voltage from the first transmission line meter 206. The first control circuit 212 is further configured to convert the voltage error signal to a direct current reference signal, receive a direct current signal from the abc/dq converter 204, and generate a direct current error signal by subtracting the direct current reference signal from the direct current reference signal.

The second control circuit 214 is configured to receive the direct current error signal and convert the direct current error signal to a quadrature voltage reference signal. The second control circuit 214 is further configured to transmit the quadrature voltage reference signal to the dq/abc converter 210.

The third control circuit 216 is configured to receive the predicted voltage V_{L} from the control system 110 and generate a voltage error signal between an AC value of the predicted voltage V_{L} and an AC value of the measured voltage from the second transmission line meter 208. The third control circuit is further configured to convert the voltage error signal to a quadrature current reference signal, receive a quadrature current signal from the abc/dq converter 204 and generate a quadrature current error signal by subtracting the quadrature current reference signal from the quadrature current reference signal.

The fourth control circuit 218 is configured to receive the quadrature current error signal and convert the quadrature current error signal to a direct voltage reference signal and transmit the direct voltage reference signal to the dq/abc converter 210. The dq/abc converter 210 is configured to receive the quadrature voltage reference signal and the direct voltage reference signal, correct the phase error of the quadrature voltage reference signal and the direct voltage reference signal and generate a corrected three phase voltage signal.

The pulse width modulator 220 is operatively connected to the dq/abc converter 210. The pulse width modulator 220 is configured to generate drive signals and transmit the drive signals to the voltage source converter 118 to control the gate terminals G₁ₐ, G₂ₐ, G_{1b}, G_{2b}, G₃ₐ and G_{3b} of the plurality of selectable switches 122-(1-6) based on the corrected three phase voltage signal.

The fifth control circuit 222 is configured receive from the DC/DC converter 120, the power P_{L} generated by DC current and the voltage V_{L} across the superconducting coil 126. The fifth control circuit 222 is configured to generate a power error by subtracting the power P_{L} from a reference power P_{L-ref}, converting the power error to a duty cycle error ΔD, limiting the duty cycle error between an upper bound of 0.5 and a lower bound of −0.5, multiplying the limited duty cycle error by 0.5 and generating a set of duty cycle control signals. The fifth control circuit 222 is further configured to transmit the duty cycle control signals to the gate terminals G_{M1} and G_{M2} of the DC/DC converter 120 to control a charge cycle and a discharge cycle of the superconducting coil 126 of the SMES device 102.

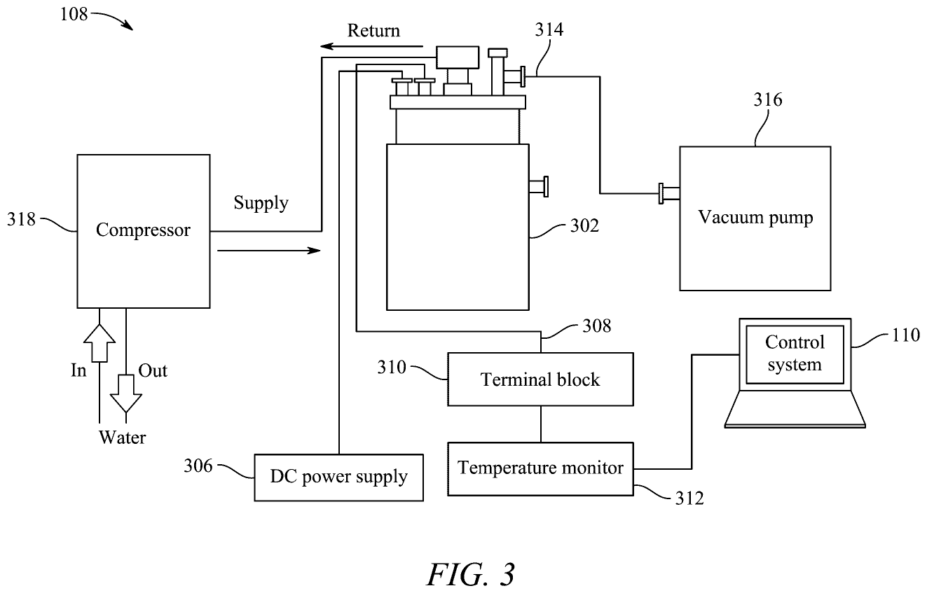

FIG. 3 illustrates the cryogenic refrigeration system 108 of the system 100.

The cryogenic refrigeration system 108 (interchangeably referred to as refrigeration system 108) includes a refrigeration unit 302, a DC power supply terminal 304 of the refrigeration unit 302 connected to a DC power supply 306, a terminal block input terminal 308 of the refrigeration unit 302 connected to a terminal block 310, a temperature monitor 312 connected to the terminal block 310, a vacuum pump port 314 of the refrigeration unit 302 connected to a vacuum pump 316, and a compressor 318 configured to pump water from a water source to the refrigeration unit 302. The temperature monitor 312 is connected to the control system 110. The refrigeration unit 302 is configured to cool the water to a cryogenic temperature and pump the water to the SMES device 102 to cool the superconducting coil 126.

According to aspect of the present disclosure, the SMES device 102 includes four parts. First part is the superconducting magnet and its supporting structure. The first part includes a superconducting coil 126, magnet, and protection facilities. The superconducting coil 126 may be implemented as a solenoid or a toroid. The second part includes the refrigeration system 108 that maintains the superconducting state of the superconducting coil 126 by cooling it at the operating temperature. The third part includes the power conditioning system 106. The power conditioning system 106 realizes DC/AC conversion to connect the SMES device 102 to the three phase power system 104. The fourth part includes the control system 110 which monitors the power flow from and to the superconducting coil 126.

FIG. 4A illustrates a series circuit model 402 of the SMES device 102, according to certain embodiments.

The series circuit model 402 (interchangeably referred to as series model) of the SMES device 102 includes a series connection of the DC power input to a resistor R representing an internal resistance of the superconducting coil 126 and an inductor L representing the superconducting coil 126, a DC current entering the resistor R and the voltage V_{L} across the inductor L. In an aspect, the SMES device 102 is represented by a series connection of an inductor and resistor to formulate power losses in charge and/discharge processes in constant power applications.

In an aspect, the power balance equation for the series circuit model 402 of the SMES device 102 is formulated as Equation (1) provided below.

$$P + R \cdot {i}^{2} = {V}_{L \cdot } i \qquad ( 1 )$$

In the above Equation (1), P is a predicted DC power input to the superconducting coil 126 of the SMES device 102 based on the predicted DC current and predicted voltage, R is an equivalent internal resistance of the superconducting coil 126, V_{L} is the voltage across the superconducting coil 126, L is an equivalent inductance of the superconducting coil 126, and i is the current of the SMES device 102.

FIG. 4B illustrates a parallel circuit model 404 of the SMES device 102, according to certain embodiments.

In an aspect, the parallel circuit model 404 (interchangeably referred to as parallel model) of the SMES device 102 includes a parallel connection of the DC power input, a resistor R representing an internal resistance of the superconducting coil 126 and an inductor L representing the superconducting coil 126, a DC current which exits the inductor L and a voltage V_{L} across the inductor L. In an aspect, the SMES device 102 is represented by a parallel connection of an inductor and resistor to formulate power losses in charge and/discharge processes in constant power applications.

In an aspect, the power balance equation for the parallel circuit model 404 of the SMES device 102 is formulated as Equation (2) provided below.

$$P + \frac{{V}_{L}^{2}}{R} = {V}_{L} \cdot i \qquad ( 2 )$$

In the above Equation (2), P is a predicted DC power input to the superconducting coil 126 of the SMES device 102 based on the predicted DC current and predicted voltage, R is an equivalent internal resistance of the superconducting coil 126, V_{L} is the voltage across the superconducting coil 126, L is an equivalent inductance of the superconducting coil 126, and i is the current of the SMES device 102.

According to aspects of the present disclosure, for both the series circuit model 402 and the parallel circuit model 404 of the SMES device 102, the discharge process is characterized by the predicted DC power input to the superconducting coil 126 of the SMES device 102 being greater than zero (i.e., P>0), while the charging process is characterized by the predicted DC power input to the superconducting coil 126 of the SMES device 102 being less than zero (i.e., P<0),

The charging and discharging processes of the SMES device 102 at constant power for the series circuit model 402 is described below.

The relationship between the current and voltage of the reactor is described in Equation (3) provided below.

$${V}_{L} = L \frac{di}{dt} \qquad ( 3 )$$

Thus, the power balance in Equation (1) can be transformed to Equation (4).

$$P + R \cdot {i}^{2} + i \cdot L \frac{di}{dt} = 0 \qquad ( 4 )$$

Accordingly, the solution to Equation (4) in terms of the initial starting current I₀ is provided in Equation (5).

$$i = \sqrt{- \frac{P}{R} + \frac{( P + R \cdot {I}_{0}^{2} )}{R} {e}^{- \frac{2 R}{L} t}} \qquad ( 5 )$$

In an aspect, V_{L} has the analytical solution given in Equation (6).

$${V}_{L} = L \frac{di}{dt} = - ( P + R \cdot {I}_{0}^{2} ) \cdot \frac{{e}^{- \frac{2 R}{L} t}}{\sqrt{- \frac{P}{R} + \frac{( P + R \cdot {I}_{0}^{2} )}{R} {e}^{- \frac{2 R}{L} t}}} \qquad ( 6 )$$

The charging and discharging processes of the SMES device 102 at constant power for the parallel circuit model 404 is described below.

In an aspect, the Equation (2) can be rearranged as Equation (7) provided below.

$${( \frac{di}{dt} )}^{2} + \frac{R}{L} ( \frac{di}{dt} ) + \frac{P R}{{L}^{2}} = 0 \qquad ( 7 )$$

The Equation (7) has two solutions for charging and discharging processes. One of the solutions is represented as Equation (8).

$$\frac{di}{dt} = \frac{- i + \sqrt{{i}^{2} - 4 \frac{P}{R}}}{2 \frac{L}{R}} \qquad ( 8 )$$

The solution to the Equation (8) is represented as Equation (9).

$$t = {t}_{0} + \frac{a}{2} log ( i + \sqrt{{i}^{2} - b} ) - \frac{a}{2 b} {i}^{2} - \frac{a}{2 b} i \cdot \sqrt{{i}^{2} - b} \qquad ( 9 )$$

$$where a = 2 \frac{L}{R} , b = 4 \frac{P}{R} and$$

$${t}_{0} = \frac{a}{2 b} ( {I}_{0}^{2} + {I}_{0} \cdot \sqrt{{I}_{0}^{2} - b} - b \cdot log ( {I}_{0} + \sqrt{{I}_{0}^{2} - b} ) )$$

According to an aspect, the control system 110 may predict the DC current stored in the magnetic field of the superconducting coil 126 based on Equation (10) provided below.

$$i = \sqrt{\frac{P}{R}} \frac{1 + Π}{\sqrt{Π}} \qquad ( 10 )$$

where P is a predicted DC power input to the superconducting coil 126 based on the predicted DC current and predicted voltage, R is an equivalent internal resistance of the superconducting coil 126 and Π is a trancendental equation defining the predicted DC current as a function of time given by:

$$Π = χ \cdot exp ( Π ) , ∀ χ > 0 \qquad ( 11 )$$

$$where$$

$$χ = \frac{R}{4 \cdot P} \cdot {e}^{( 1 + \frac{2 R}{L} ( t - {t}_{0} ) )} \qquad ( 12 )$$

where L is an equivalent inductance of the superconducting coil 126.

The mathematical code used in solving Equation (11) is given in below.

$$diggitsnumber = 1000 ;$$

$$KSI = 1 / 7$$

$$x = 50 ;$$

$$Upper = {\sum }_{n = 0}^{x - 1} ( - 1 ) \hat{} n ★ KSI \hat{} n ★ ( ( x - 1 - n ) \hat{} n ) / n ! ;$$

$$Lower = {\sum }_{n = 0}^{x} ( - 1 ) \hat{} n ★ KSI \hat{} n ★ ( ( x - n ) \hat{} n ) / n ! ;$$

$$STFTlower = log [ ( Upper / Lower ) ] ;$$

$$errorSTFTlower = Abs [ STFTlower - KSI ★ E \hat{} STFTLlower ] ;$$

$$Print [ “ STFTlower = ” , SetPrecision [ STFTlower , diggitsnumber ] ] ;$$

$$Print [ “ errorSTFTlower = ” , \\ SetPrecision [ errorSTFTlower , diggitsnumber ] ] ;$$

$$a = 2 ★ Log [ 3 ] ; \vert$$

$$b = ST F T l o wer / a ;$$

$$U = 200 ★ a ;$$

$$R = {{\sum }^{IntegralPart [ \frac{U}{a} ]}}_{m = 0} ( ( ( - 1 ) \hat{} m ) ★ ( b \hat{} m ) ★ ( E \hat{} ( - a ★ b ★ m ) ) ★ ( ( U - m ★ a ) \hat{} m ) / m ! ) ;$$

$$Ra = {{\sum }^{IntegralPart [ \frac{{U}_{- a}}{a} ]}}_{m = 0} ( ( ( - 1 ) \hat{} m ) ★ ( b \hat{} m ) ★ ( E \hat{} ( - a ★ b ★ m ) ) ★ ( ( U - a - m ★ a ) \hat{} m ) / m ! ) ;$$

$$R 2 a = {{\sum }^{IntegralPart [ \frac{{U}_{- 2 ★ a}}{a} ]}}_{m = 0} ( ( ( - 1 ) \hat{} m ) ★ ( b \hat{} m ) ★ ( E \hat{} ( - a ★ b ★ m ) ) ★ ( ( U - 2 ★ a - m ★ a ) \hat{} m ) / m ! ) ;$$

$$Flow = b * E \hat{} ( b * U ) * ( R - ( E \hat{} ( - a * b ) ) * Ra ) ;$$

$$Fup = b * E \hat{} ( b * ( U - a ) ) * ( R a - ( E \hat{} ( - a * b ) ) * R 2 a ) ;$$

$$STFTupper = STFTlower + Log [ Fup / Flow ] ;$$

$$errorSTFTupper = Abs [ STFTupper - KSI ★ E \hat{} STFTupper ] ;$$

$$Print [ “ STFTupper = ” , SetPrecision [ STFTupper , diggitsnumber ] ] ;$$

$$Print [ “ errorSTFTupper = ” , \\ SetPrecision [ errorSTFTupper , diggitsnumber ] ] .$$

According to an aspect, the control system 110 may predict the voltage V_{L} across the superconducting coil 126 based on Equation (13).

$${V}_{L} = L \frac{di}{dt} = L \frac{di}{d Π} \cdot \frac{d Π}{dt} = L \frac{di}{d Π} \cdot \frac{d Π}{d χ} \cdot \frac{d χ}{dt} , \qquad ( 13 )$$

$${V}_{L} = \sqrt{\frac{P \cdot R}{Π}}$$

The control system 110 is further configured to predict the DC current I_{L} in the superconducting coil 126 and the voltage V_{L} across the superconducting coil 126 during discharging based on Equation (14) and Equation (15).

$$i = \sqrt{\frac{P}{R}} \frac{1 + {trans}_{>} ( χ )}{\sqrt{t r a n {s}_{>} ( χ )}} \qquad ( 14 )$$

$${V}_{L} = \sqrt{\frac{P \cdot R}{{trans}_{>} ( χ )}} \qquad ( 15 )$$

$$where$$

$${trans}_{<} ( χ ) = log ( \frac{{\sum }_{n = 0}^{[ x - 1 ]} {( - 1 )}^{n} \frac{( x - 1 - n )}{n !} {χ}^{n}}{{\sum }_{n = 0}^{[ x ]} {( - 1 )}^{n} \frac{( x - n )}{n !} {χ}^{n}} ) \qquad ( 16 )$$

$${trans}_{>} ( χ ) = t r a n {s}_{<} ( χ ) + log ( \frac{{F}_{u p}}{{F}_{low}} ) \qquad ( 17 )$$

$${F}_{low} = b \cdot {e}^{{b}_{1} , U} \cdot ( R - {e}^{- α \cdot {b}_{1}} {R}_{a} ) \qquad ( 18 )$$

$${F}_{u p} = b \cdot {e}^{{b}_{1} \cdot ( U - α )} \cdot ( {R}_{α} - {e}^{- α \cdot {b}_{1}} {R}_{2 a} ) \qquad ( 19 )$$

$$R = {\sum }_{m = 0}^{[ U / α ]} {( - 1 )}^{m} {b}_{1}^{m} {e}^{- α \cdot {b}_{1} \cdot m} \frac{{( U - m \cdot α )}^{m}}{m !} \qquad ( 20 )$$

$${R}_{α} = {\sum }_{m = 0}^{[ {( U - α )}^{- α ]}} {( - 1 )}^{m} {b}_{1}^{m} {e}^{- a \cdot {b}_{1} \cdot m} \frac{{( U - α - m \cdot α )}^{m}}{m !} \qquad ( 21 )$$

$${R}_{2 a} = {\sum }_{m = 0}^{[ ( U - 2 α ) / α ]} {( - 1 )}^{m} {b}_{1}^{m} {e}^{- α \cdot {b}_{1} \cdot m} \frac{{( U - 2 α - m \cdot α )}^{m}}{m !} \qquad ( 22 )$$

where R′ is a time derivative of the resistance R of the SMES device 102, α is an arbitrary positive real number, and where

$$α = 2 log ( 3 ) , {b}_{1} = \frac{{trans}_{<} ( x )}{α}$$

and U is a positive integer.

In an aspect, Equation (11) has two solutions. One solution is less than 1 (referred to as the lower solution, trans<), and the other solution is greater than 1 (referred to as the upper solution, trans>). The lower solution (trans<1) is given by Equation (16), while the upper solution (trans>1) is given by Equation (17).

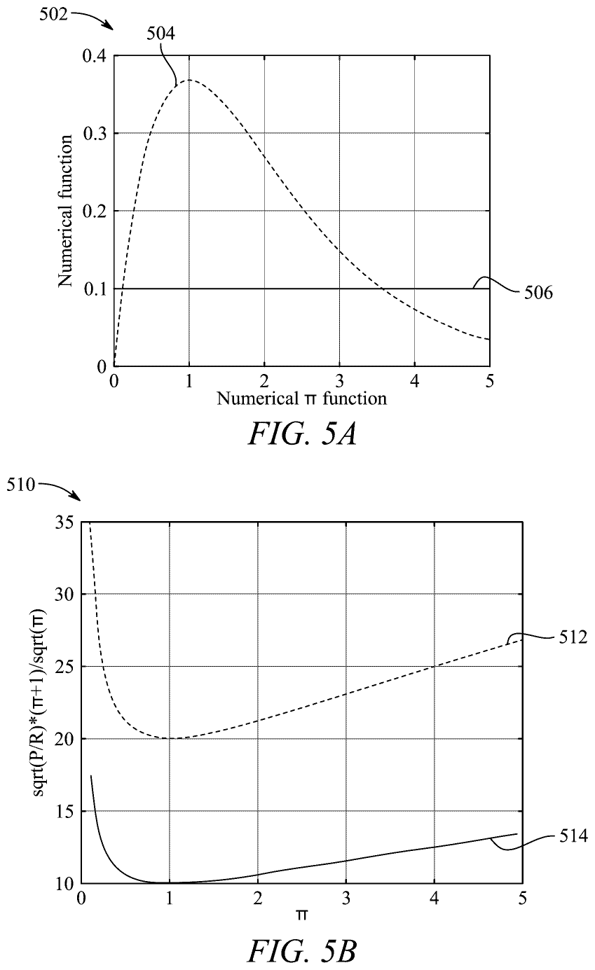

FIG. 5A illustrates a graph 502 depicting the dependency of the current i of the SMES device 102 as a function of the transcendental equation Π, according to certain embodiments.

According to an aspect, the vertical axis of the graph 502 represents the numerical function (Π·exp(−Π)), while the horizontal axis of the graph 502 represents the transcendental equation Π. The curve 504 of the graph 502 corresponds to the function (Π·exp(−Π)) and the curve 506 of the graph 502 corresponds to the function

$$χ ( χ = \frac{R}{4 \cdot P} \cdot {e}^{( 1 + \frac{2 R}{L} ( t - {t}_{0} ) )} ) .$$

During the discharge process (P>0), the current of the reactor decreases as the SMES device 102 injects energy, leading to a gradual decrease in current over time. However, analyzing

$$χ = \frac{R}{4 \cdot P} \cdot {e}^{( 1 + \frac{2 R}{L} ( t - {t}_{0} ) )}$$

reveals that as time progresses, χ increases. The rise in χ results in an increase in the lower solution and a decrease in the upper solution of χ.

FIG. 5B illustrates a graph 510 representing the dependency of the current i of the SMES device 102 as another function of the transcendental equation Π, according to certain embodiments.

According to an aspect, the vertical axis of the graph 510 represents the numerical function i, i.e.,

$$\sqrt{\frac{P}{R}} \frac{1 + Π}{\sqrt{Π}} ,$$

while the horizontal axis of the graph 510 represents the transcendental equation Π. The curve 512 of the graph 510 corresponds to

$$\sqrt{\frac{P}{R}} = 10 ,$$

and the curve 514 of the graph corresponds to

$$\sqrt{\frac{P}{R}} = 5.$$

By observing the graph 510, it is evident that for trans_{>}, a decrease in Π results in a corresponding decrease in the current i of the SMES device 102. Based on this analysis, it is apparent that the upper solution is more applicable during the discharge process, i.e., trans>.

According to an aspect, the control system 110 is configured to predict the DC current I_{L} in the superconducting coil 126 and the voltage V_{L} across the superconducting coil 126 during discharging to be given by Equation (24) and Equation (25).

$$i = \sqrt{\frac{P}{R}} \frac{1 + t r a n s > ( χ )}{t r a n s > ( χ )} , \qquad ( 24 )$$

$${V}_{L} = \sqrt{\frac{P \cdot R}{t r a n s > ( χ )}} , \qquad ( 26 )$$

According to an aspect, the modeling of the charging process of the SMES device 102 at constant power is described below.

For the charging process P<0, it may be assumed Pc=−P. Therefore, based on this, a different differential equation for the SMES current is given in below.

$$\frac{di}{dt} = \frac{- i + \sqrt{{i}^{2} + 4 \frac{{P}_{c}}{R}}}{2 \frac{L}{R}} \qquad ( 27 )$$

The solution of the differential equation (27) is provided below.

$$t = \frac{a}{2} log ( i + \sqrt{{i}^{2} + b} ) + \frac{a}{2 b} {i}^{2} + \frac{a}{2 b} i \cdot \sqrt{{i}^{2} + b} - {t}_{0 c} \qquad ( 28 )$$

$$where$$

$${t}_{0 c} = \frac{a}{2 b} ( {I}_{0}^{2} + {I}_{0} \cdot \sqrt{{I}_{0}^{2} + b} + b \cdot log ( {I}_{0} + \sqrt{{I}_{0}^{2} + b} ) ) . \qquad ( 29 )$$

According to an aspect, to define the current as a function of time, the Equation (28) can be first rearranged in the following transcendental equation.

$$Λ = δ \cdot exp ( - Λ ) , ∀ δ > 0 \qquad ( 30 )$$

$$where$$

$$δ = \frac{R}{4 \cdot {P}_{c}} \cdot {e}^{( 1 + \frac{2 R}{L} \cdot ( {t}_{0 c} + t ) )} \qquad ( 31 )$$

Based on the Equation (30) and Equation (31), the SMES current has following expression:

$$i = \sqrt{\frac{{P}_{c}}{R}} ( \frac{Λ - 1}{\sqrt{Λ}} ) \qquad ( 32 )$$

Based on the Equation (30) and Equation (31), the SMES voltage has following expression:

$${V}_{L} = \sqrt{\frac{{P}_{c} \cdot R}{Λ}} \qquad ( 33 )$$

Equation (30) represents the Lambert's W equation and has one solution. Equation (30) can be solved in various ways. For a small value δ, the analytical solution is accurate if the Perovich special trans function is used, where the solution is noted as transL. Therefore, using the Perovich special trans function, the control system 110 is further configured to predict the DC current I_{L} in the superconducting coil 126 and the voltage V_{L} across the superconducting coil 126 during charging to be given by Equation (34).

$$i = \sqrt{\frac{{P}_{c}}{R}} \frac{t r a n {s}_{L} ( δ ) - 1}{\sqrt{t r a n {s}_{L} ( δ )}} \qquad ( 34 )$$

$$and$$

$${V}_{L} = \sqrt{\frac{{P}_{c} \cdot R}{t r a n {s}_{L} ( δ )}} \qquad ( 35 )$$

where:

$$t r a n {s}_{L} ( δ ) = δ \frac{{\sum }_{n = o}^{M} \frac{{{δ}^{n} ( M - n )}^{n}}{n !}}{{\sum }_{n = 0}^{M + 1} \frac{{{δ}^{n} ( M + 1 - n )}^{n}}{n !}} \qquad ( 36 )$$

where M is a positive integer.

In an aspect, the minimum value of the integer M is 1. The maximum value is theoretically infinity. However, a remarkably high level of accuracy can be obtained for limited values of M (for example, M=50 or M=100). A higher value of parameter M may result in increased accuracy. Further, theoretically, the variable δ has a value from

$${δ}_{min} = {δ}_{t = 0} = \frac{R}{4 {P}_{c}} \cdot {e}^{( 1 + \frac{2 R}{L} {t}_{0 c} )} ,$$

which increases with time.

Data from an actual SMES device 102 installed in Japan was investigated to evaluate the accuracy of performed analytical expressions for current and voltage during both charging and discharging process. For the SMES device, the primary data for the superconducting coil is 21.1 H and an apparent power is 10 MVA.

The electrical performance of the series model based SMES device 102 at constant power is described below.

Table 1 shows the current and voltage values of the series model based SMES device 102 for two values of charging and discharging power (i.e, 500 kW and 1 MW) at R=0.1Ω.

TABLE 1
Charging and discharging of the series model based SMES
device 102 for two values of charging and discharging power
(500 kW and 1 MW) at R = 0.1 Ω, L = 21 H, I₀ = 1350 A

| | Power | | | | | | | |
|---|---|---|---|---|---|---|---|---|
| | P = 500 kW | | | | P = 1 MW | | | |
| | Mode | | | | | | | |
| | Discharge | | Charge | | Discharge | | Charge | |
| | SMES | SMES | SMES | SMES | SMES | SMES | SMES | SMES |
| | Current | Voltage | Current | Voltage | Current | Voltage | Current | Voltage |
| t | (kA) | (V) | (kA) | (V) | (kA) | (V) | (kA) | (V) |
| 0.0 | 1.3500 | 505.3704 | 1.3500 | 235.3704 | 1.3500 | 0.8757 | 1.3500 | 605.7407 |
| 0.5 | 1.3379 | 507.5025 | 1.3556 | 233.2881 | 1.3290 | 0.8853 | 1.3643 | 596.5388 |
| 1.0 | 1.3258 | 509.7048 | 1.3611 | 231.2365 | 1.3078 | 0.8954 | 1.3784 | 587.6332 |
| 1.5 | 1.3137 | 511.9801 | 1.3666 | 229.2149 | 1.2864 | 0.9060 | 1.3923 | 579.0079 |
| 2.0 | 1.3015 | 514.3315 | 1.3720 | 227.2226 | 1.2647 | 0.9172 | 1.4060 | 570.6479 |
| 2.5 | 1.2892 | 516.7620 | 1.3774 | 225.2587 | 1.2427 | 0.9290 | 1.4195 | 562.5397 |
| 3.0 | 1.2768 | 519.2750 | 1.3828 | 223.3228 | 1.2204 | 0.9414 | 1.4328 | 554.6703 |
| 3.5 | 1.2644 | 521.8740 | 1.3880 | 221.4141 | 1.1979 | 0.9546 | 1.4459 | 547.0281 |
| 4.0 | 1.2520 | 524.5628 | 1.3933 | 219.5320 | 1.1750 | 0.9686 | 1.4588 | 539.6018 |
| 4.5 | 1.2395 | 527.3454 | 1.3985 | 217.6760 | 1.1517 | 0.9834 | 1.4716 | 532.3813 |
| 5.0 | 1.2269 | 530.2260 | 1.4037 | 215.8454 | 1.1281 | 0.9992 | 1.4842 | 525.3569 |
| 5.5 | 1.2142 | 533.2091 | 1.4088 | 214.0396 | 1.1042 | 1.0161 | 1.4966 | 518.5197 |
| 6.0 | 1.2015 | 536.2995 | 1.4139 | 212.2582 | 1.0798 | 1.0341 | 1.5089 | 511.8612 |
| 6.5 | 1.1887 | 539.5025 | 1.4189 | 210.5005 | 1.0549 | 1.0534 | 1.5210 | 505.3736 |
| 7.0 | 1.1758 | 542.8234 | 1.4239 | 208.7661 | 1.0296 | 1.0742 | 1.5329 | 499.0496 |
| 7.5 | 1.1628 | 546.2682 | 1.4288 | 207.0545 | 1.0037 | 1.0966 | 1.5447 | 492.8820 |
| 8.0 | 1.1498 | 549.8432 | 1.4337 | 205.3652 | 0.9773 | 1.1209 | 1.5564 | 486.8646 |
| 8.5 | 1.1366 | 553.5551 | 1.4386 | 203.6977 | 0.9503 | 1.1473 | 1.5679 | 480.9910 |
| 9.0 | 1.1234 | 557.4111 | 1.4434 | 202.0517 | 0.9227 | 1.1761 | 1.5793 | 475.2555 |
| 9.5 | 1.1101 | 561.4192 | 1.4482 | 200.4265 | 0.8943 | 1.2076 | 1.5906 | 469.6527 |
| 10.0 | 1.0967 | 565.5877 | 1.4530 | 198.8218 | 0.8652 | 1.2424 | 1.6017 | 464.1773 |

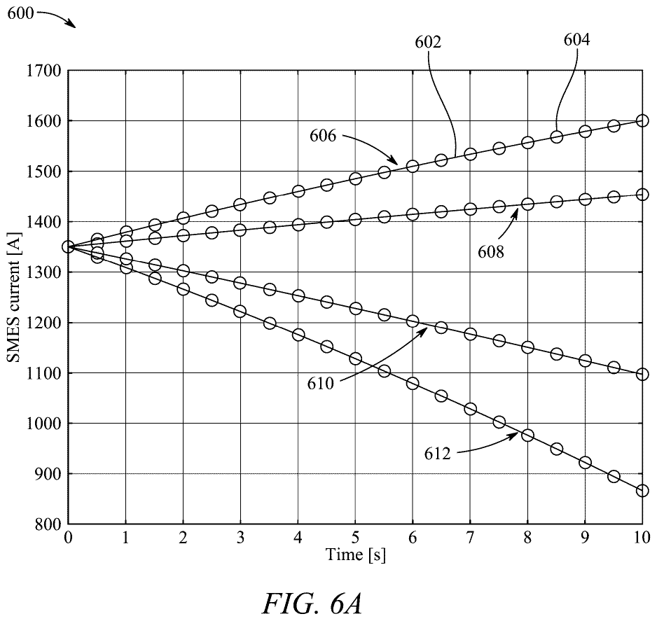

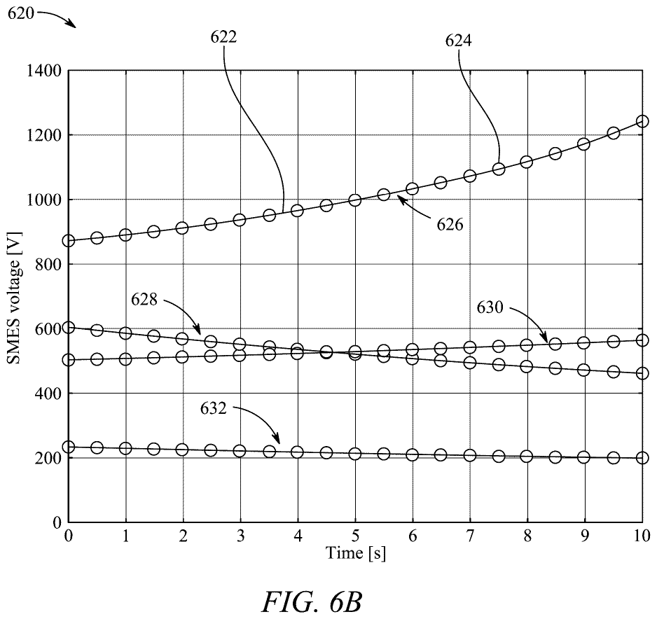

FIG. 6A illustrates a graph 600 representing values of charging and discharging currents for series model based SMES device 102 at power values of 500 kW and 1 MW.

In FIG. 6A, line 602 represents numerical results obtained through numerical integration with steps of 10⁻⁵. Further, circle markers 604 represent results derived from analytical solutions. Charging current is shown at power value of 1 MW (represented by reference numeral 606). Charging current is shown at power value of 500 kW (represented by reference numeral 608). Discharging current is shown at power value of 500 kW (represented by reference numeral 610). Discharging current is shown at power value of 1 MW (represented by reference numeral 612). As shown in FIG. 6A, the numerical and analytical results are closely aligned.

FIG. 6B illustrates a graph 620 representing values of charging and discharging voltages for series model based SMES device 102 at power values of 500 kW and 1 MW.

In FIG. 6B, line 622 represents numerical results obtained through numerical integration with steps of 10⁻⁵. Further, circle markers 624 represent results derived from analytical solutions. Discharging voltage is shown at power value of 1 MW (represented by reference numeral 626). Charging voltage is shown at power value of 1 MW (represented by reference numeral 628). Discharging voltage is shown at power value of 500 kW (represented by reference numeral 630). Charging voltage is shown at power value of 500 kW (represented by reference numeral 632). As shown in FIG. 6B, the numerical and analytical results are closely aligned.

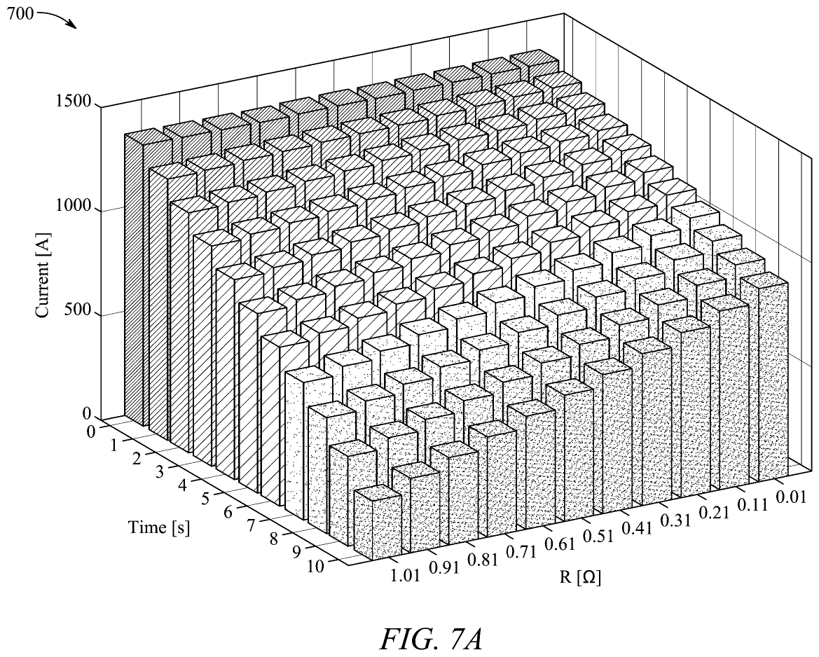

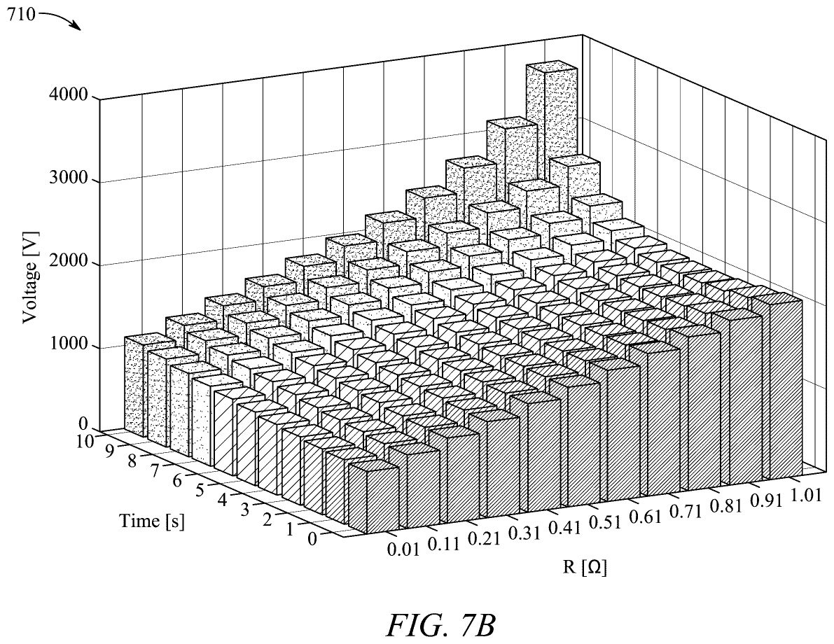

FIG. 7A illustrates a three dimensional (3D) visualization 700 of change in current as a function of time during discharging for different resistance values for the series model based SMES device 102. As shown in FIG. 7A, increasing the resistance leads to a rapid reduction in the value of the discharging current. Further, the current decreases during the discharging of the SMES device 102.

FIG. 7B illustrates a 3D visualization 710 of change in voltage as a function of time during discharging for different resistance values for the series model based SMES device 102. The voltage increases during the discharging of the SMES device 102. The current increases as the resistance of the SMES device 102 decreases.

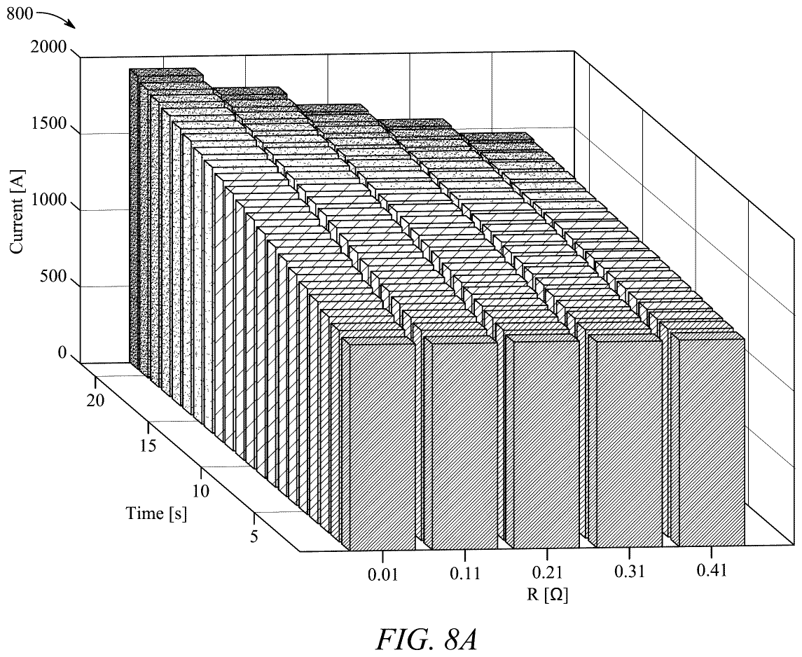

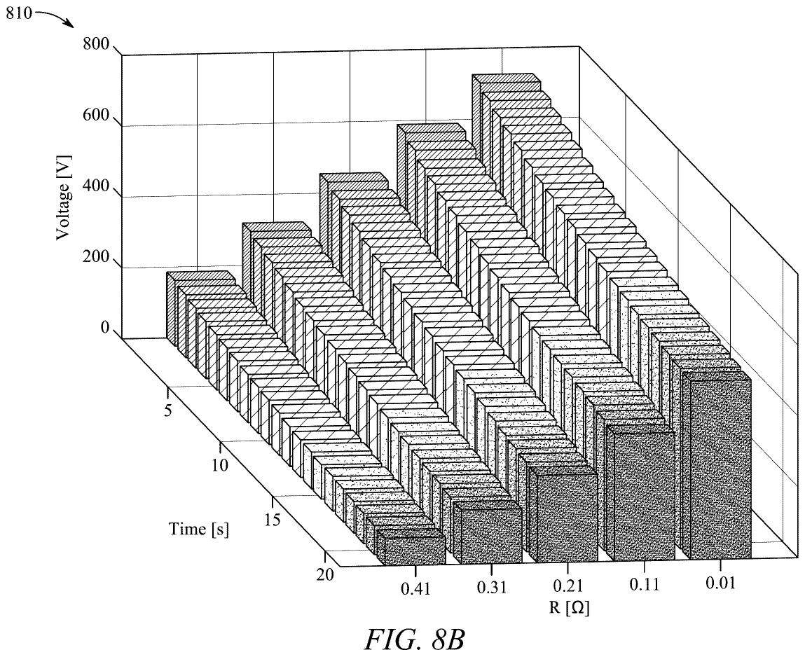

FIG. 8A illustrates a 3D visualization 800 of change in current as a function of time during charging for different resistance values for the series model based SMES device 102. As can be seen in FIG. 8A, increasing the resistance leads to slower growth in its value during the charging process. Further, the current increases during the charging of the SMES device 102 and has its highest value for the lowest resistance value 0.01 ohms.

FIG. 8B illustrates a 3D visualization 810 of change in voltage as a function of time during charging for different resistance values for the series model based SMES device 102. As can be seen in FIG. 8B, increasing the resistance leads to slower growth in its value during the charging process. Further, the voltage decreases during the charging of the SMES device 102 and has its highest voltage values at the lowest resistance value of 0.01 ohms.

The electric performance of the parallel model based SMES device 102 at constant power is described below.

Table 2 shows the current and voltage values of the parallel model based SMES device 102 for two values of charging and discharging power (i.e., 500 kW and 1 MW) at R=100Ω.

TABLE 2
Charging and discharging of the parallel model based SMES
device 102 for two values of charging and discharging power
(500 kW and 1 MW) at R = 100 Ω, L = 21 H, I₀ = 1350 A

| | Power | | | | | | | |
|---|---|---|---|---|---|---|---|---|
| | P = 500 kW | | | | P = 1 MW | | | |
| | Mode | | | | | | | |
| | Discharge | | Charge | | Discharge | | Charge | |
| | SMES | SMES | SMES | SMES | SMES | SMES | SMES | SMES |
| | Current | Voltage | Current | Voltage | Current | Voltage | Current | Voltage |
| T | (kA) | (V) | (kA) | (V) | (kA) | (V) | (kA) | (V) |
| 0.0 | 1.3500 | 371.3921 | 1.3500 | 369.3598 | 1.3500 | 0.7449 | 1.3500 | 736.7203 |
| 0.5 | 1.3411 | 373.8627 | 1.3588 | 366.9897 | 1.3321 | 0.7549 | 1.3674 | 727.4294 |
| 1.0 | 1.3322 | 376.3834 | 1.3675 | 364.6647 | 1.3140 | 0.7655 | 1.3846 | 718.4801 |
| 1.5 | 1.3232 | 378.9558 | 1.3761 | 362.3831 | 1.2957 | 0.7764 | 1.4016 | 709.8521 |
| 2.0 | 1.3142 | 381.5819 | 1.3847 | 360.1438 | 1.2771 | 0.7879 | 1.4184 | 701.5268 |
| 2.5 | 1.3050 | 384.2634 | 1.3933 | 357.9455 | 1.2582 | 0.7999 | 1.4351 | 693.4867 |
| 3.0 | 1.2959 | 387.0023 | 1.4018 | 355.7868 | 1.2390 | 0.8124 | 1.4515 | 685.7161 |
| 3.5 | 1.2866 | 389.8008 | 1.4102 | 353.6667 | 1.2195 | 0.8256 | 1.4677 | 678.2001 |
| 4.0 | 1.2773 | 392.6610 | 1.4186 | 351.5839 | 1.1997 | 0.8394 | 1.4838 | 670.9253 |
| 4.5 | 1.2679 | 395.5853 | 1.4270 | 349.5375 | 1.1795 | 0.8540 | 1.4997 | 663.8791 |
| 5.0 | 1.2585 | 398.5760 | 1.4353 | 347.5263 | 1.1590 | 0.8693 | 1.5154 | 657.0496 |
| 5.5 | 1.2489 | 401.6358 | 1.4435 | 345.5495 | 1.1381 | 0.8856 | 1.5309 | 650.4261 |
| 6.0 | 1.2393 | 404.7672 | 1.4517 | 343.6059 | 1.1168 | 0.9027 | 1.5464 | 643.9984 |
| 6.5 | 1.2297 | 407.9733 | 1.4599 | 341.6947 | 1.0951 | 0.9209 | 1.5616 | 637.7571 |
| 7.0 | 1.2199 | 411.2569 | 1.4680 | 339.8149 | 1.0729 | 0.9403 | 1.5767 | 631.6934 |
| 7.5 | 1.2101 | 414.6213 | 1.4761 | 337.9659 | 1.0503 | 0.9609 | 1.5917 | 625.7989 |
| 8.0 | 1.2002 | 418.0699 | 1.4841 | 336.1466 | 1.0272 | 0.9830 | 1.6065 | 620.0660 |
| 8.5 | 1.1902 | 421.6061 | 1.4921 | 334.3563 | 1.0035 | 1.0066 | 1.6212 | 614.4875 |
| 9.0 | 1.1801 | 425.2339 | 1.5000 | 332.5944 | 0.9792 | 1.0321 | 1.6358 | 609.0565 |
| 9.5 | 1.1699 | 428.9572 | 1.5079 | 330.8599 | 0.9543 | 1.0596 | 1.6502 | 603.7666 |
| 10.0 | 1.1596 | 432.7803 | 1.5158 | 329.1523 | 0.9287 | 1.0895 | 1.6645 | 598.6120 |

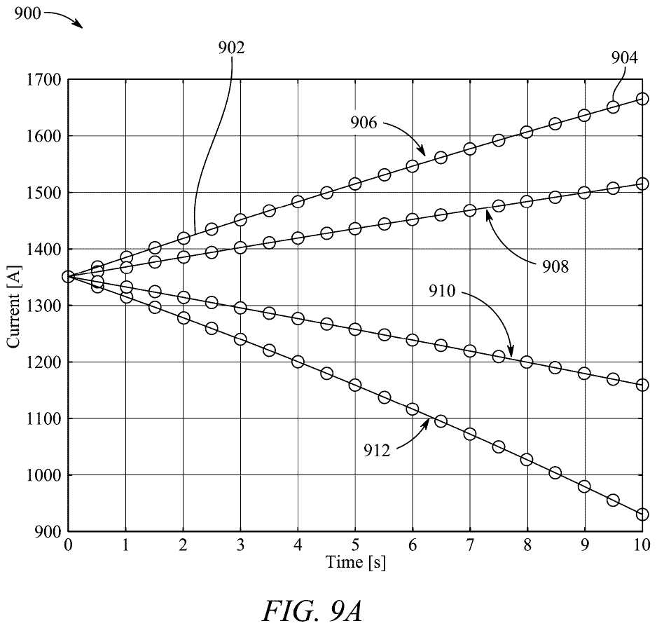

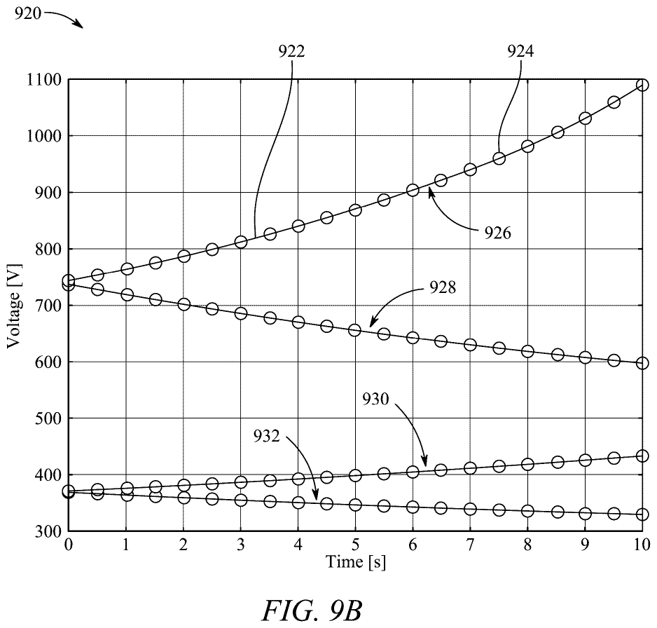

FIG. 9A illustrates a graph 900 representing values of charging and discharging currents for parallel model based SMES device 102 at power values of 500 kW and 1 MW. In FIG. 9A, line 902 represents numerical results obtained through numerical integration with steps of 10⁻⁵. Further, circle markers 904 represent results derived from analytical solutions. Charging current is shown at a power value of 1 MW (represented by reference numeral 906). Charging current is shown at a power value of 500 kW (represented by reference numeral 908). Discharging current is shown at a power value of 500 kW (represented by reference numeral 910). Discharging current is shown at a power value of 1 MW (represented by reference numeral 912). As shown in FIG. 9A, the numerical results coincide with the analytical results, which confirms the design of the SMES device 102 in constant power applications.

FIG. 9B illustrates a graph 920 representing values of charging and discharging voltages for parallel model based SMES device 102 at power values of 500 kW and 1 MW.

In FIG. 9B, line 922 represents numerical results obtained through numerical integration with steps of 10⁻⁵. Further, circle markers 924 represent results derived from analytical solutions. Discharging voltage is shown at a power value of 1 MW (represented by reference numeral 926). Charging voltage is shown at a power value of 1 MW (represented by reference numeral 928). Discharging voltage is shown at a power value of 500 kW (represented by reference numeral 930). Charging voltage is shown at a power value of 500 kW (represented by reference numeral 932). As can be seen in FIG. 9A, the numerical results coincide with the analytical results, which confirms the design of the SMES device 102 in constant power applications.

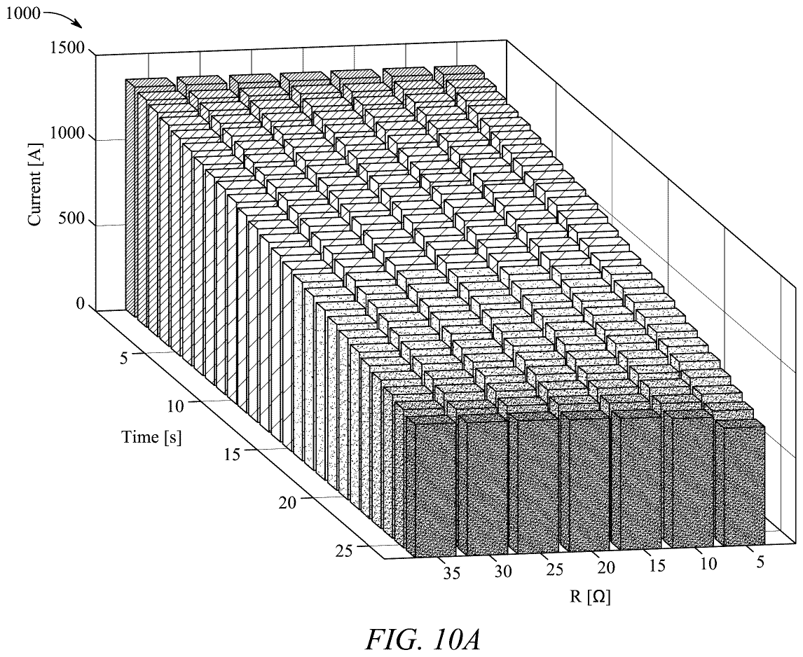

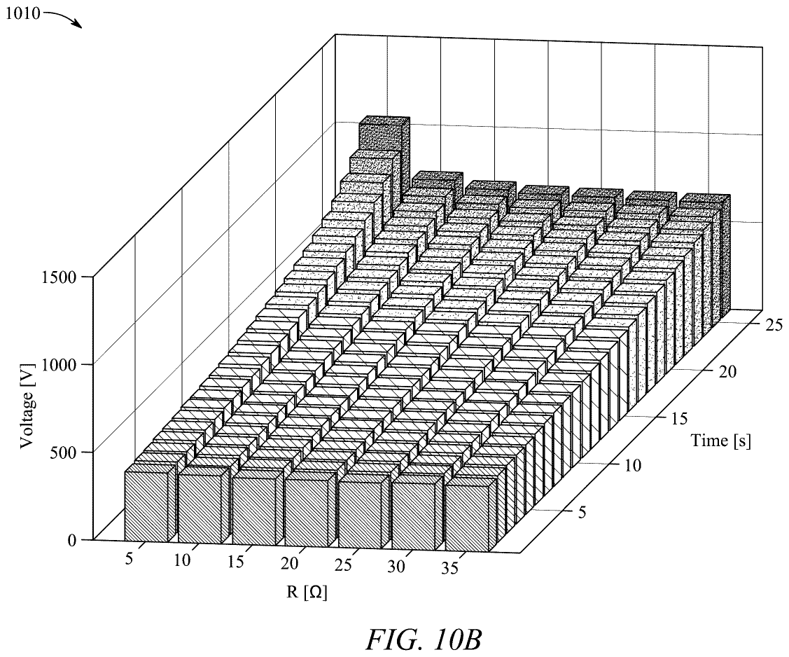

FIG. 10A illustrates the 3D visualization 1000 of the change in current as a function of time during discharging for different resistance values for the parallel model based SMES device 102. As can be seen in FIG. 10A, increasing the resistance leads to a rapid reduction in the value of the discharging current. The current decreases during the discharging of the SMES device 102.

FIG. 10B illustrates a 3D visualization 1010 of change in voltage as a function of time during discharging for different resistance values for the parallel model based SMES device 102. The voltage increases during the discharging of the SMES device 102.

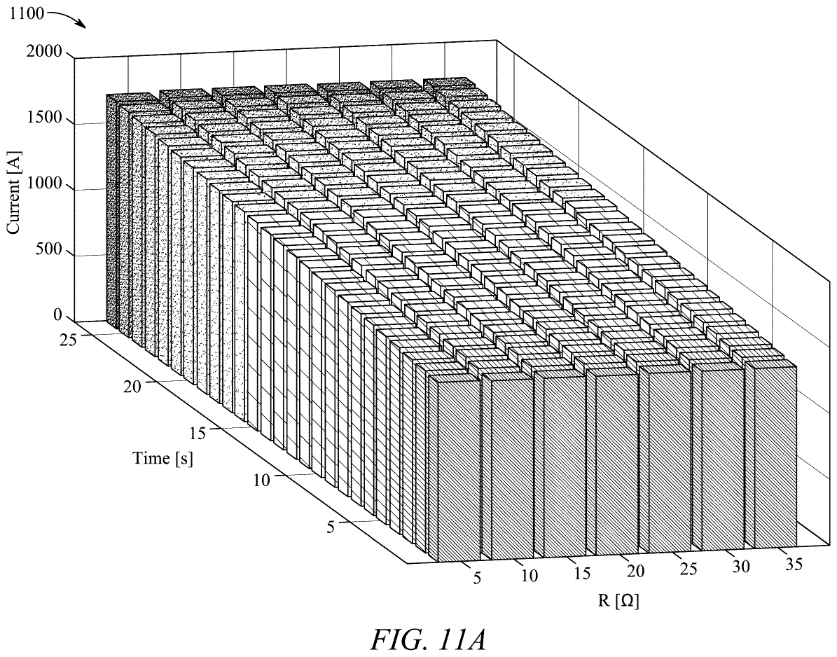

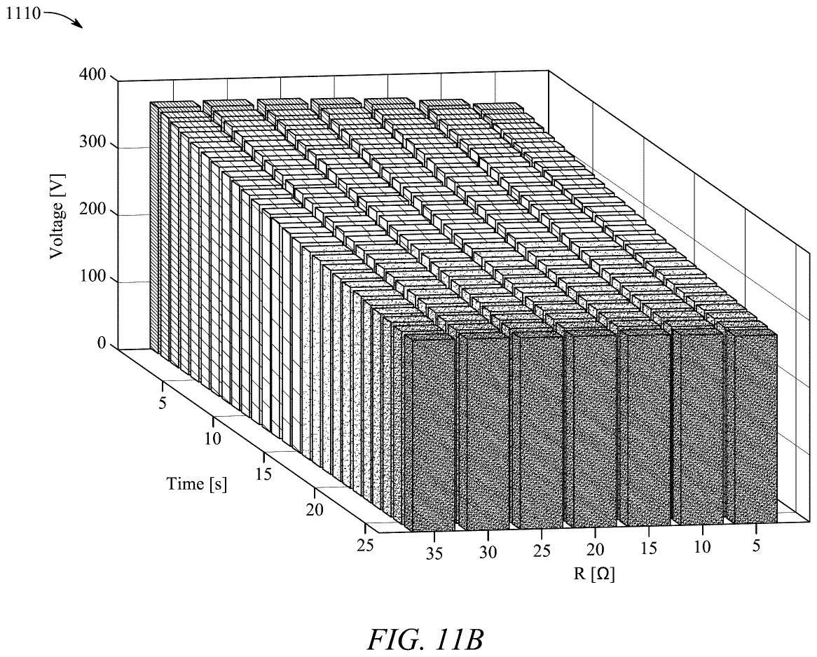

FIG. 11A illustrates a 3D visualization 1100 of change in current as a function of time during charging for different resistance values for the parallel model based SMES device 102. Increasing the resistance leads to slower growth in its value during the charging process. The current increases during the charging of the SMES device 102.

FIG. 11B illustrates a 3D visualization 810 of change in voltage as a function of time during charging for different resistance values for the parallel model based SMES device 102. Increasing the resistance leads to slower growth in its value during the charging process. The voltage decreases during the charging of the SMES device 102.

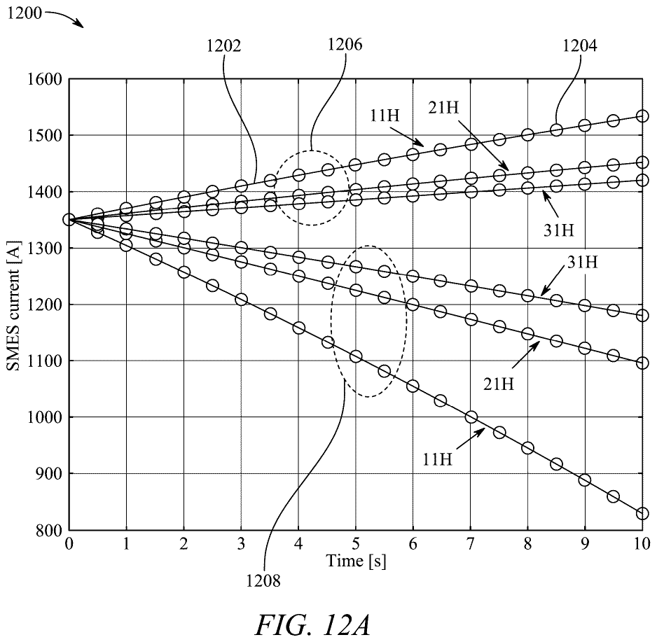

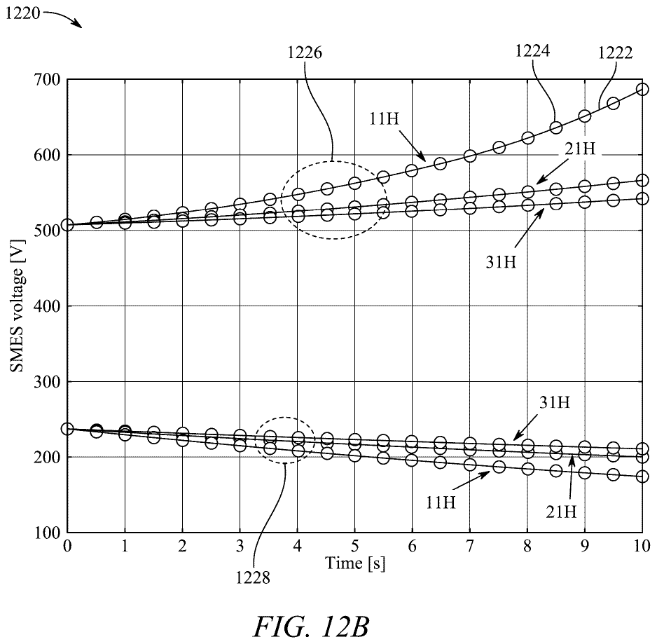

FIG. 12A illustrates a graph 1200 representing an impact of inductance on current during the charging and discharging of the series model based SMES device 102 at a power value of 500 kW with variable inductance and resistance of 0.1Ω.

In FIG. 12A, line 1202 represents numerical results obtained through numerical integration with steps of 10⁻⁵. Further, circle markers 1204 represent results derived from analytical solutions. Charging process is represented by reference numeral 1206 and discharging process is represented by reference numeral 1208. As shown in FIG. 12A, high inductance values cause a slight decrease in the current during the discharging process and a slow increase in current during the charging process.

FIG. 12B illustrates a graph 1220 representing an impact of inductance on voltage during the charging and discharging of the series model based SMES device 102 at power value of 500 kW with variable inductance and resistance of 0.1Ω.

In FIG. 12B, line 1222 represents numerical results obtained through numerical integration with steps of 10⁻⁵. Further, circle markers 1224 represent results derived from analytical solutions. The discharging process is represented by reference numeral 1226 and charging process is represented by reference numeral 1228. As shown in FIG. 12B, a higher inductance value during the charging process leads to a slower voltage drop, while during the discharge process, a slower voltage rise is exhibited.

Using circuit analysis, an approximate parallel combination of inductance and resistance can be obtained for each series-based combination of inductance and its series-connected resistance.

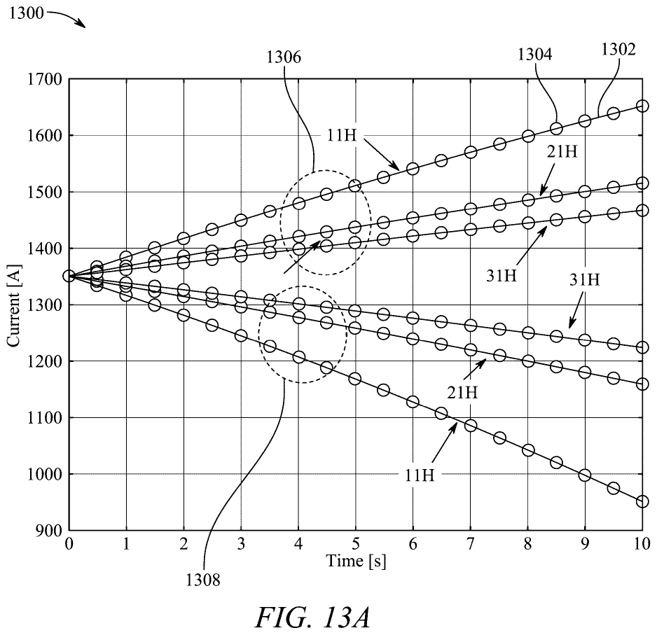

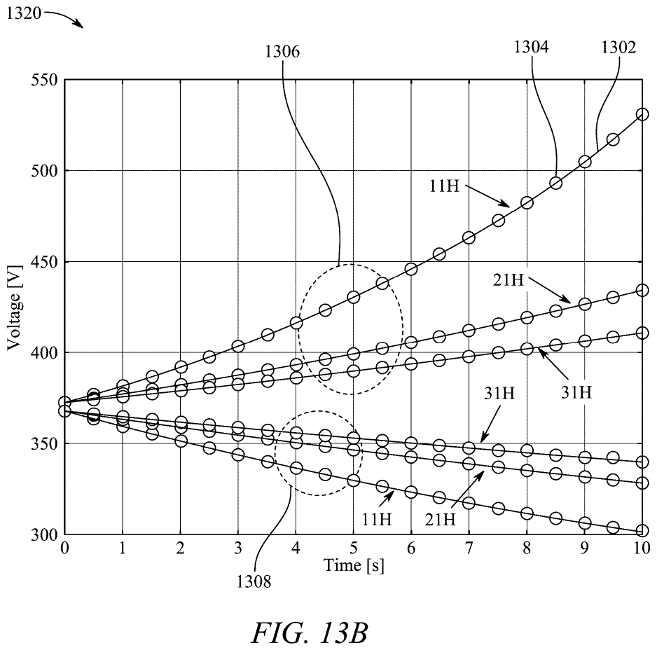

FIG. 13A illustrates a graph 1300 representing an impact of inductance on current during the charging and discharging of the parallel model based SMES device 102 at a power value of 500 kW with variable inductance and resistance of 50Ω.

In FIG. 13A, line 1302 represents numerical results obtained through numerical integration with steps of 10⁻⁵. Further, circle markers 1304 represent results derived from analytical solutions. The charging process is represented by reference numeral 1306 and the discharging process is represented by reference numeral 1308. As shown in FIG. 13A, high inductance values cause a slight decrease in the current during the discharging process and a slow increase in current during the charging process.

FIG. 13B illustrates a graph 1320 representing an impact of inductance on voltage during the charging and discharging of the parallel model based SMES device 102 at power value of 500 kW with variable inductance and resistance of 50Ω.

In FIG. 13B, line 1322 represents numerical results obtained through numerical integration with steps of 10⁻⁵. The circle markers 1324 represent results derived from analytical solutions. The discharging process is represented by reference numeral 1326 and the charging process is represented by reference numeral 1328. As shown in FIG. 13B, a high inductance value during the charging process leads to a slower voltage drop, while during the discharging process, it leads to a slower voltage rise.

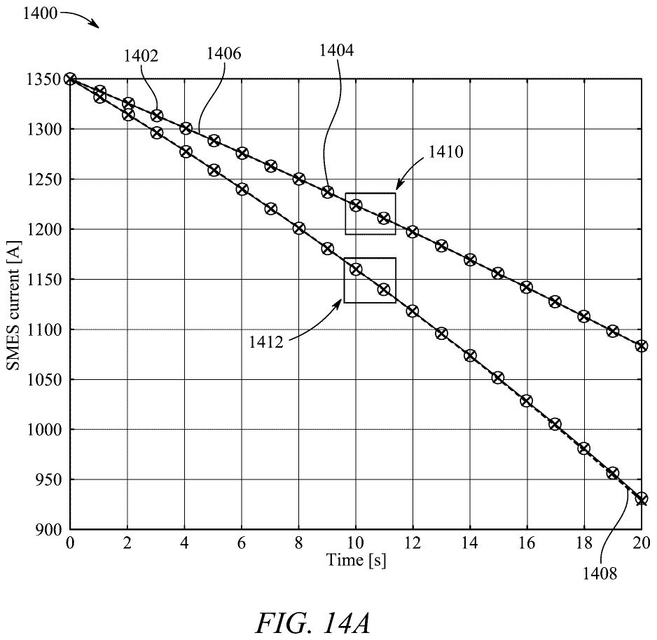

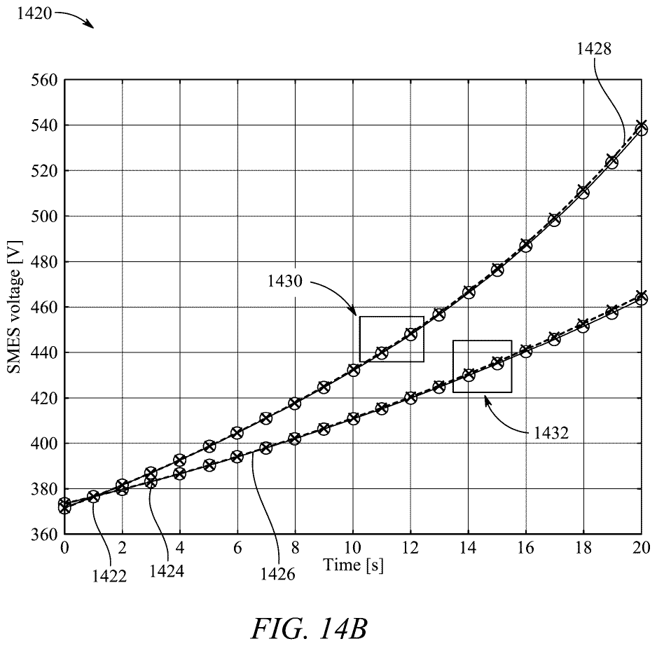

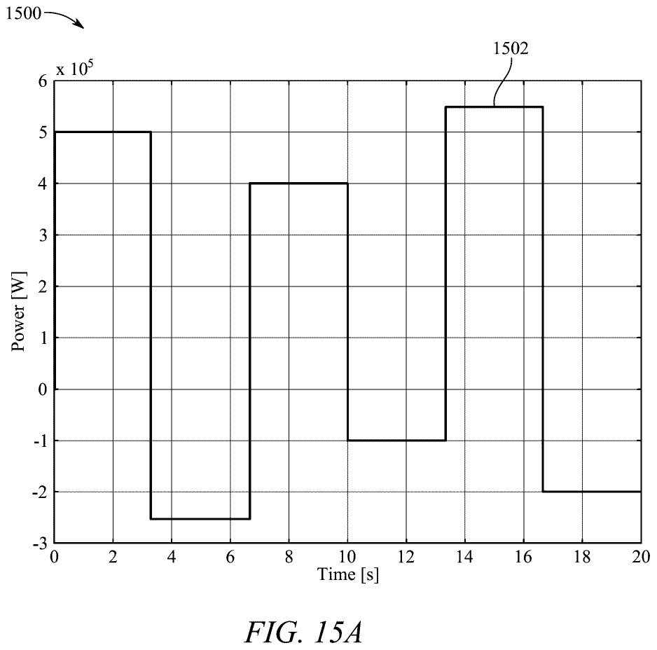

FIG. 14A illustrates a graph 1400 representing current changes for series and parallel parameter value combinations during discharge process at a power of 500 kW.

In FIG. 14A, circle markers 1402 represent results derived from analytical solutions when resistor R and inductor L are connected in series, cross markers 1404 represent results derived from analytical solutions when resistor R and inductor L are connected in parallel, solid line 1406 represents numerical results obtained through numerical integration when resistor R and inductor L are connected in series, and dashed line 1408 represents numerical results obtained through numerical integration when resistor R and inductor L are connected in parallel. As can be seen in FIG. 14A, the series and parallel parameter value combinations provide same current changes during the discharge process at a power of 500 kW. Element 1410 may represent Rₚₐᵣₐₗₗₑₗ of 50 ohms and Rₛₑᵣᵢₑₛ of 0.002 ohms with L=31 H. Element 1412 may represent Rₚₐᵣₐₗₗₑₗ of 100 ohms and Rₛₑᵣᵢₑₛ of 0.001 ohms with L=11 H.

FIG. 14B illustrates a graph 1420 representing voltage changes for series and parallel parameter value combinations during the discharge process at a power of 500 kW.

In FIG. 14B, circle markers 1422 represent results derived from analytical solutions when resistor R and inductor L are connected in series, cross markers 1424 represent results derived from analytical solutions when resistor R and inductor L are connected in parallel, solid line 1426 represents numerical results obtained through numerical integration when resistor R and inductor L are connected in series, and dashed line 1428 represents numerical results obtained through numerical integration when resistor R and inductor L are connected in parallel. As can be seen in FIG. 14B, the series and parallel parameter value combinations provide same voltage changes during the discharge process at a power of 500 kW. Element 1430 may represent Rₚₐᵣₐₗₗₑₗ of 100 Ohms and Rₛₑᵣᵢₑₛ of 0.001 Ohms with L=11 H. Element 1412 may represent Rₚₐᵣₐₗₗₑₗ of 50 Ohms and Rₛₑᵣᵢₑₛ of 0.002 Ohms with L=31 H.

In real applications, such as renewable energy systems, SMES devices typically undergo alternating charging and discharging processes. Due to the intermittent nature of renewable energy sources, SMES devices absorb energy during periods of high renewable generation and supply energy to the AC utility grid when renewable output is limited. The present disclosure provides both analytical and numerical results for successive charging and discharging cycles of the SMES devices, exploring a range of charging and discharging power values. The findings highlight the practical relevance of the series and parallel circuit models in real-world scenarios.

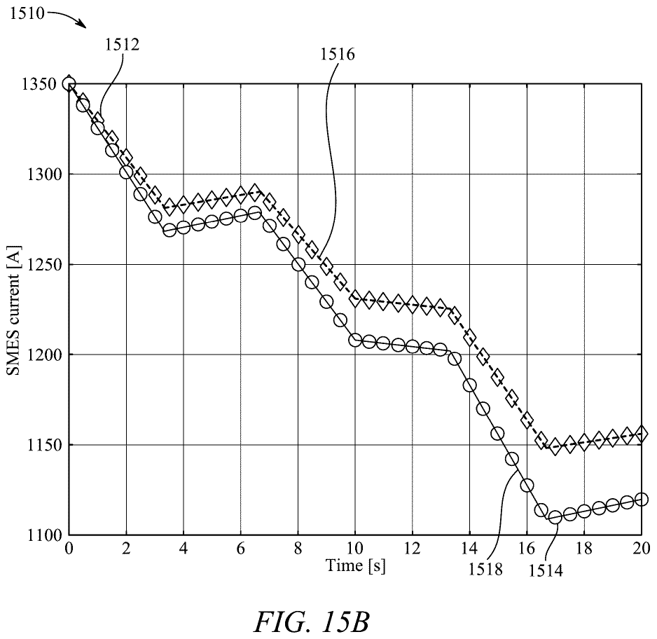

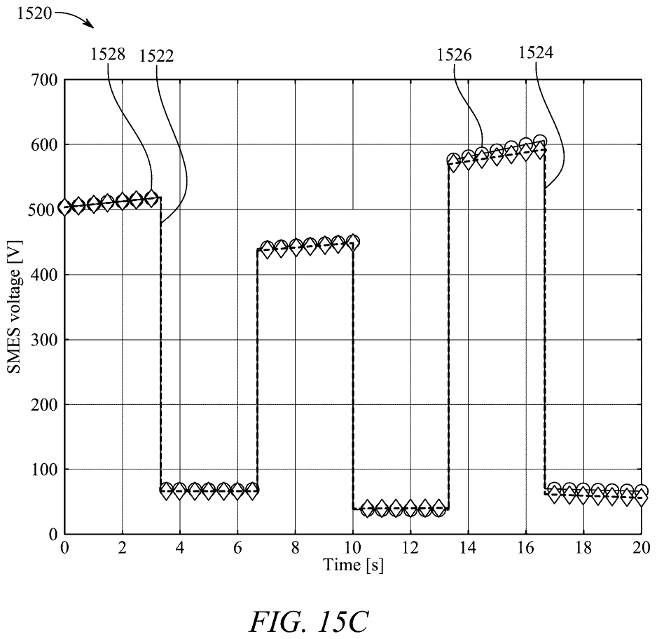

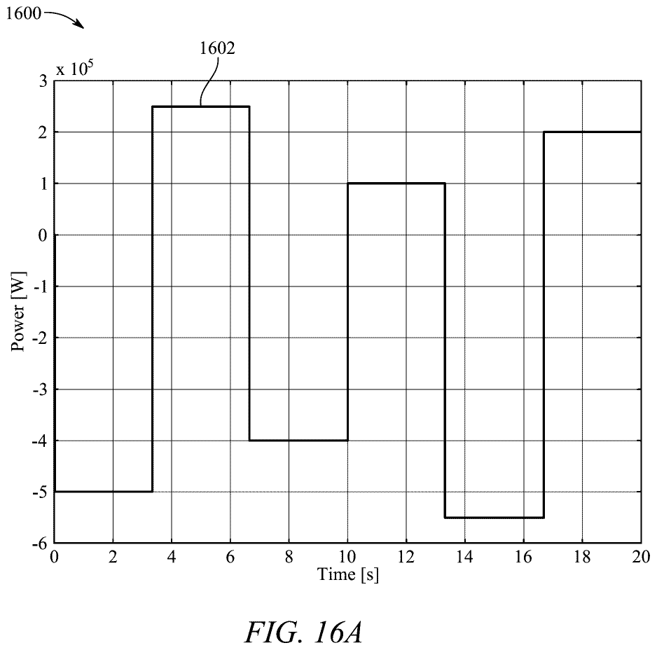

FIG. 15A illustrates a graph 1500 representing a power variation pattern 1502 for current and voltage change during charging for the series model based SMES device 102 at R=0.1Ω.

FIG. 15B illustrates a graph 1510 representing current change during charging for successive power variations for the series model based SMES device 102 at R=0.1Ω. In FIG. 15B, diamond markers 1512 represent results derived from the analytical solutions for an inductance of 25 H, circle markers 1514 represent results derived from the analytical solutions for an inductance of 21 H, dashed line 1516 represents numerical results obtained through numerical integration for an inductance of 25 H, and solid line 1518 represents numerical results obtained through numerical integration for an inductance of 21 H.

FIG. 15C illustrates a graph 1520 representing voltage change during charging for successive power variations for the series model based SMES device 102 at R=0.1Ω.

In FIG. 15C, dashed line 1522 represents numerical results obtained through numerical integration for an inductance of 25 H, solid line 1524 represents numerical results obtained through numerical integration for an inductance of 21 H, circle markers 1526 represent results derived from the analytical solutions for an inductance of 21 H, and diamond markers 1528 represent results derived from the analytical solutions for an inductance of 25 H.

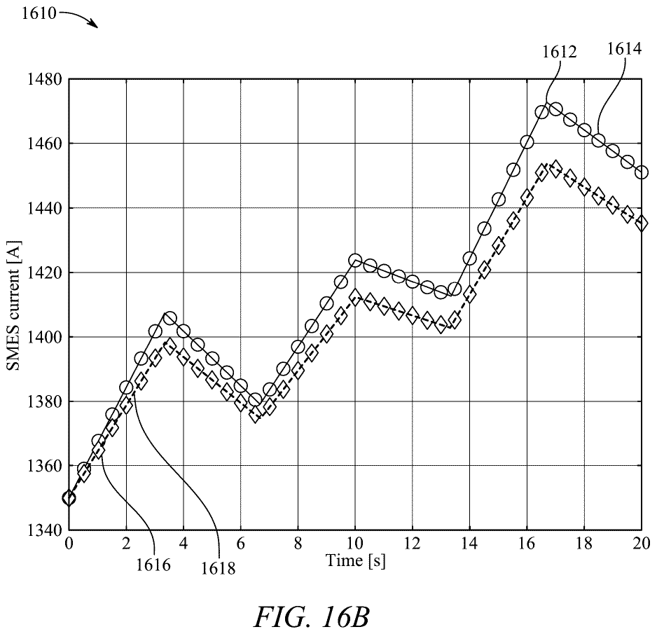

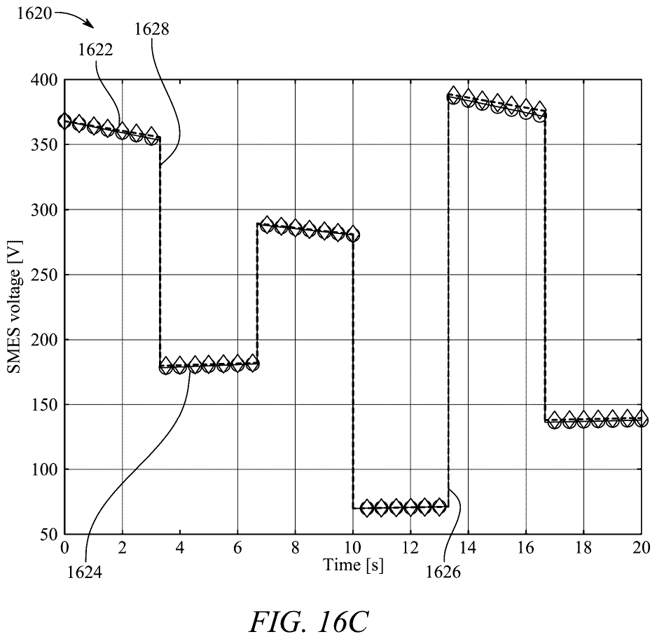

FIG. 16A illustrates a graph 1600 representing a power variation pattern 1602 for current and voltage change during charging for the parallel model based SMES device 102 at R=50Ω.

FIG. 16B illustrates a graph 1610 representing current change during charging for successive power variations for the parallel model based SMES device 102 at R=50Ω.

In FIG. 16B, solid line 1612 represents numerical results obtained through numerical integration for an inductance of 21 H, circle markers 1614 represent results derived from the analytical solutions for an inductance of 21 H, diamond markers 1616 represent results derived from the analytical solutions for an inductance of 25 H, and dashed line 1618 represents numerical results obtained through numerical integration for an inductance of 25 H.

FIG. 16C illustrates a graph 1620 representing voltage change during charging for successive power variations for the parallel model based SMES device 102 at R=50Ω.

In FIG. 16C, dashed line 1622 represents numerical results obtained through numerical integration for an inductance of 25 H, circle markers 1624 represent results derived from the analytical solutions for an inductance of 21 H, solid line 1626 represents numerical results obtained through numerical integration for an inductance of 21 H, and diamond markers 1628 represent results derived from the analytical solutions for an inductance of 25 H.

As can be observed in FIG. 15A to FIG. 16C, for both the series based model of the SMES device 102 and the parallel based model of the SMES device 102, the analytical results are in complete agreement with the numerical results. Therefore, the accuracy of the derived expressions and their applicability for analyzing the successive charging and discharging of SMES device 102 is evident. During nominal operations, the current changes continuously, ensuring the safety of the SMES device 102.

According to various aspects of the present disclosure, for both the series based model of the SMES device 102 and the parallel based model of the SMES device 102, analytical closed-form expressions for both charge and discharge operation processes at constant power are derived, and the results obtained using the derived expressions when compared with those obtained using numerical methods, enables a high degree of matching. Further, when the analytical expressions for both the series based model of the SMES device 102 and the parallel based model of the SMES device 102 are used to investigate voltage and current changes under successive changes in the operating conditions, the analytical results are in complete agreement with the numerical results. Both the models contribute to the suitable design, modeling, investigation, testing (efficiency, protection devices, rate of charge, and discharge), and control of practical SMES in all constant power applications in industrial and modern energy systems.

Various embodiments of the present disclosure are described through FIG. 1A to FIG. 16C.

In one exemplary embodiment, a method for controlling charging and discharging of a superconducting magnetic energy storage (SMES) device. controlling charging and discharging of a superconducting magnetic energy storage (SMES) device. The method includes connecting a three phase input terminal of a power conditioning system to a three phase power system. The power conditioning system includes an AC/DC converter and a plurality of selectable switches. The method further includes connecting an input terminal and an output terminal of a superconducting coil of the SMES device to the power conditioning system. The method also includes receiving, by the SMES device, a DC current from the power conditioning system. The SMES device includes a magnet surrounded by the superconducting coil. The superconducting coil is configured to store the DC current in a magnetic field of the superconducting coil.

The method further includes connecting a control system to the power conditioning system, a cryogenic refrigeration system and the SMES device. The control system includes a memory storing an equivalent circuit model of the SMES device and program instructions including a Perovich special trans function and Lambert's W equation, and at least one processor configured for executing the program instructions for deriving, by the control system, a set of transcendental equations for a voltage across the superconducting coil and the DC current stored in the magnetic field of the superconducting coil based on the equivalent circuit model; and solving, by the at least one processor, the set of transcendental equations to predict a voltage V_{L} across the superconducting coil and the DC current I_{L} stored in the magnetic field of the superconducting coil using the Perovich special trans function theory and Lambert's W equation, actuating, by the control system, the plurality of selectable switches based on the predicted voltage and the predicted DC current to perform one of charging the superconducting coil with the DC current and storing the DC current in the magnetic field of the superconducting coil; and discharging the superconducting coil to generate a discharge DC current, converting the discharge DC current to AC power in the power conditioning system, and transmitting the AC power to the three phase power system.

In an aspect, the method further includes predicting, by the control system, the DC current stored in the magnetic field based on:

$$i = \sqrt{\frac{P}{R}} \frac{1 + Π}{\sqrt{Π}} ,$$

where P is a predicted DC power input to the superconducting coil based on the predicted DC current and predicted voltage, R is an equivalent internal resistance of the superconducting coil and Π is a trancendental equation defining the predicted DC current as a function of time given by:

$$Π = χ \cdot exp ( Π ) , ∀ χ > 0 ,$$

where χ is given by:

$$χ = \frac{R}{4 \cdot P} \cdot {e}^{( 1 + \frac{2 R}{L} ( t - {t}_{0} ) )} ,$$

and
where L is an equivalent inductance of the superconducting coil.

In an aspect, the method includes predicting, by the control system, the voltage V_{L} across the superconducting coil based on:

$${V}_{L} = \sqrt{\frac{P \cdot R}{Π}} .$$

In an aspect, the method includes predicting, by the control system, the DC current I_{L} in the superconducting coil and the voltage V_{L} across the superconducting coil during discharging to be given by:

$$i = \sqrt{\frac{P}{R}} \frac{1 + {trans}_{>} ( χ )}{\sqrt{{trans}_{>} ( χ )}} , and$$

$${V}_{L} = \sqrt{\frac{P \cdot R}{{trans}_{>} ( χ )}} ,$$

where trans_{>}(χ) is given by:

$${trans}_{>} ( χ ) = t r a n {s}_{<} ( χ ) + log ( \frac{{F}_{u p}}{{F}_{low}} ) ,$$

where:

$${F}_{u p} = b \cdot {e}^{{b}_{1} \cdot ( U - α )} \cdot ( {R}_{α} - {e}^{- α \cdot {b}_{1}} {R}_{2 a} ) ,$$

$${F}_{low} = b \cdot {e}^{{b}_{1} , U} \cdot ( R - {e}^{- α \cdot {b}_{1}} {R}_{a} ) ,$$

$$R = {\sum }_{m = 0}^{[ U / α ]} {( - 1 )}^{m} {b}_{1}^{m} {e}^{- α \cdot {b}_{1} \cdot m} \frac{{( U - m \cdot α )}^{m}}{m !} ,$$

$${R}_{α} = {\sum }_{m = 0}^{[ {( U - α )}^{- α ]}} {( - 1 )}^{m} {b}_{1}^{m} {e}^{- a \cdot {b}_{1} \cdot m} \frac{{( U - α - m \cdot α )}^{m}}{m !} ,$$

$${R}_{2 a} = {\sum }_{m = 0}^{[ ( U - 2 α ) / α ]} {( - 1 )}^{m} {b}_{1}^{m} {e}^{- α \cdot {b}_{1} \cdot m} \frac{{( U - 2 α - m \cdot α )}^{m}}{m !} , and$$

$${trans}_{<} ( χ ) = log ( \frac{{\sum }_{n = 0}^{[ x - 1 ]} {( - 1 )}^{n} \frac{( x - 1 - n )}{n !} {χ}^{n}}{{\sum }_{n = 0}^{[ x ]} {( - 1 )}^{n} \frac{( x - n )}{n !} {χ}^{n}} )$$

where α=2 log(3), b=4/R, b₁=trans_{<}(x)/α and U is a positive integer.

In an aspect, the method includes predicting, by the control system, the DC current I_{L} in the superconducting coil and the voltage V_{L} across the superconducting coil during charging to be given by:

$$i = \sqrt{\frac{{P}_{c}}{R}} \frac{{trans}_{L} ( δ ) - 1}{\sqrt{t r a n {s}_{L} ( δ )}} ,$$

$$and$$

$${V}_{L} = \sqrt{\frac{{P}_{c} \cdot R}{t r a n {s}_{L} ( δ )}} ,$$

where:

$$t r a n {s}_{L} ( δ ) = δ \frac{{\sum }_{n = 0}^{M} \frac{{{δ}^{n} ( M - n )}^{n}}{n !}}{{\sum }_{n = 0}^{M + 1} \frac{{{δ}^{n} ( M + 1 - n )}^{n}}{n !}}$$

where M is a positive integer and

$$δ = \frac{R}{4 \cdot {P}_{c}} \cdot {e}^{( 1 + \frac{2 R}{L} \cdot ( {t}_{0 c} + t ) )} .$$

In an aspect, the equivalent circuit model of the SMES comprises a series connection of the DC power input to a resistor R representing an internal resistance of the superconducting coil and an inductor L representing the superconducting coil, having a DC current entering the resistor R and a voltage V_{L} across the inductor L.

In an aspect, the equivalent circuit model of the SMES comprises a parallel connection of the DC power input, a resistor R representing an internal resistance of the superconducting coil and an inductor L representing the superconducting coil, having a DC current which exits the inductor L and a voltage V_{L} across the inductor L.

In another exemplary embodiment, system for controlling charge and discharge cycles of a superconducting magnetic energy storage (SMES) device. The system includes a three phase power system, a power conditioning system configured with a set of three phase input terminals. The set of three phase input terminals are connected by a transformer to a set of three phase output terminals of the three phase power system. The system further includes a superconducting magnetic energy storage (SMES) device operatively connected to the power conditioning system. The SMES device includes a superconducting coil, a cryogenic refrigeration system operatively connected to the SMES device, a control system connected to the power conditioning system, the cryogenic refrigeration system and the SMES.

The control system includes a memory storing an equivalent circuit model of the SMES and program instructions including a Perovich special trans function and Lambert's W equation, and at least one processor configured for executing the program instructions to derive a set of transcendental equations for a voltage across the superconducting coil and a DC current stored in the magnetic field of the superconducting coil based on the equivalent circuit model, predict a voltage V_{L} across the superconducting coil and the DC current I_{L} stored in the magnetic field of the superconducting coil by solving the set of transcendental equations to using the Perovich special trans function theory and Lambert's W equation, actuate the power conditioning system based on the predicted voltage and the predicted DC current to perform one of charge the superconducting coil with the DC current and storing the DC current in the magnetic field of the superconducting coil, and discharge the superconducting coil to generate a discharge DC current, convert the discharge DC current to AC power in the power conditioning system, and transmit the AC power to the three phase power system.

In an aspect, the equivalent circuit model of the SMES comprises a series connection of the DC power input to a resistor R representing an internal resistance of the superconducting coil and an inductor L representing the superconducting coil, a DC current entering the resistor R and the voltage V_{L} across the inductor L.

In an aspect, the equivalent circuit model of the SMES comprises a parallel connection of the DC power input, a resistor R representing an internal resistance of the superconducting coil and an inductor L representing the superconducting coil, a DC current which exits the inductor L and a voltage V_{L} across the inductor L.

In an aspect, the power conditioning system further includes an AC/DC converter including a voltage source converter comprising a plurality of selectable switches connected to the set of three phase input terminals and a capacitor connected parallel to the voltage source converter, and a DC/DC converter connected parallel to the voltage source converter and the DC-link capacitor, wherein the DC/DC converter includes a set of DC output terminals configured to connect to the SMES device.

In an aspect, the plurality of selectable switches includes three sets of series connected N-channel MOSFET transistors each having an antiparallel diode. The first set includes a first N-channel MOSFET transistor T₁ₐ having a drain terminal connected to a positive bus line, a gate terminal G₁ₐ, and a source terminal and a second N-channel MOSFET transistor T₂ₐ having a drain terminal connected to the source terminal of the first N-channel MOSFET transistor T₁ₐ, a gate terminal G₂ₐ and a source terminal connected to a negative bus line, wherein the source terminal of the first N-channel MOSFET transistor T₁ₐ is connected to a first phase terminal Pₐ of the set of three phase input terminals.

The second set includes a first N-channel MOSFET transistor T_{1b} having a drain terminal connected to the positive bus line, a gate terminal G_{1b} and a source terminal and a second N-channel MOSFET transistor T_{2b} having a drain terminal connected to the source terminal of the first N-channel MOSFET transistor T_{1b}, a gate terminal G_{2b} and a source terminal connected to the negative bus line, wherein the source terminal of the first N-channel MOSFET transistor T_{1b} is connected to a second phase terminal P_{b} of the set of three phase input terminals.

The third set includes a first N-channel MOSFET transistor T_{1c} having a drain terminal connected to the positive bus line, a gate terminal G_{1c}, and a source terminal and a second N-channel MOSFET transistor T_{2c} having a drain terminal connected to the source terminal of the first N-channel MOSFET transistor T_{1c}, a gate terminal G_{2c} and a source terminal connected to the negative bus line, wherein the source terminal of the first N-channel MOSFET transistor T_{1c} is connected to a third phase terminal P_{c} of the set of three phase input terminals.

In an aspect, the DC-link capacitor has a first terminal connected to the positive bus line and a second terminal connected to the negative bus line.

In an aspect, the DC/DC converter comprises a first N-channel MOSFET transistor M₁ having a drain terminal connected to the positive bus line, a gate terminal G_{M1} and a source terminal connected to an input terminal of the superconducting coil of the SMES device, a first reverse diode D₁ having an output terminal connected to the source terminal of the first N-channel MOSFET transistor M₁ and an input terminal connected to the negative bus line, a second reverse diode D₂ having an output terminal to the positive bus line, and a second N-channel MOSFET transistor M₂ having a source terminal connected to the negative bus line, a gate terminal G_{M2} and a drain terminal connected to an output terminal of the superconducting coil of the SMES device.

In an aspect, the power conditioning system further comprises a phase locked loop circuit, an abc/dq converter operatively connected to the phase locked loop circuit, a first transmission line meter connected to a set of three phase transmission lines of the three phase power system, wherein the first transmission line meter is located on the set of three transmission lines between the three phase power system and the transformer, wherein the first transmission line meter is configured to measure a voltage of each of the three phase transmission lines and transmit the measured voltages to the phase locked loop, wherein the phase locked loop is configured to generate a phase error of the measured voltages with respect to a reference phase angle.

In an aspect, the power conditioning system further includes a second transmission line meter connected to the three phase transmission lines located on the set of three transmission lines between the transformer and the power conditioning system, wherein the second transmission line meter is configured to measure a current on each of the three phase transmission lines and a voltage on each of the three phase transmission lines and transmit the measured currents to the abc/dq converter.

In an aspect, the power conditioning system includes a dq/abc converter operatively connected to an output terminal of the phase locked loop circuit, wherein the dq/abc converter is configured to receive the phase error.

In an aspect, the power conditioning system includes a first control circuit configured to receive the predicted voltage V_{L} from the control system, generate a voltage error signal between a DC value of the predicted voltage V_{L} and a DC value of the measured voltage from the first transmission line meter, convert the voltage error signal to a direct current reference signal, receive a direct current signal from the abc/dq converter and generate a direct current error signal by subtracting the direct current reference signal from the direct current reference signal.

In an aspect, the power conditioning system includes a second control circuit configured to receive the direct current error signal and convert the direct current error signal to a quadrature voltage reference signal and transmit the quadrature voltage reference signal to the dq/abc converter.

In an aspect, the power conditioning system includes a third control circuit configured to receive the predicted voltage V_{L} from the control system, generate a voltage error signal between an AC value of the predicted voltage V_{L} and an AC value of the measured voltage from the second transmission line meter, convert the voltage error signal to a quadrature current reference signal, receive a quadrature current signal from the abc/dq converter and generate a quadrature current error signal by subtracting the quadrature current reference signal from the quadrature current reference signal.

In an aspect, the power conditioning system includes a fourth control circuit configured to receive the quadrature current error signal and convert the quadrature current error signal to a direct voltage reference signal and transmit the direct voltage reference signal to the dq/abc converter.

In an aspect, the dq/abc converter is configured to receive the quadrature voltage reference signal and the direct voltage reference signal, correct the phase error of the quadrature voltage reference signal and the direct voltage reference signal and generate a corrected three phase voltage signal.

In an aspect, the power conditioning system includes a pulse width modulator operatively connected to the dq/abc converter, wherein the pulse width modulator is configured to generate drive signals and transmit the drive signals to the voltage source converter to control the gate terminals G₁ₐ, G₂ₐ, G_{1b}, G_{2b}, G₃ₐ and G_{3b} of the plurality of selectable switches based on the corrected three phase voltage signal.

In an aspect, the power conditioning system further includes a fifth control circuit configured to receive, from the DC/DC converter, the power P_{L} generated by DC current and the voltage V_{L} across the superconducting coil, generate a power error by subtracting the power P_{L} from a reference power P_{L-ref}, convert the power error to a duty cycle error ΔD, limit the duty cycle error between an upper bound of 0.5 and a lower bound of −0.5, multiply the limited duty cycle error by 0.5 and generate a set of duty cycle control signals and transmit the duty cycle control signals to the gate terminals G_{M1} and G_{M2} of the DC/DC converter to control a charge cycle and a discharge cycle of the superconducting coil of the SMES device.

In an aspect, the cryogenic refrigeration system includes a refrigeration unit, a DC power supply terminal of the refrigeration unit connected to a DC power supply, a terminal block input terminal of the refrigeration unit connected to a terminal block, a temperature monitor connected to the terminal block, wherein the temperature monitor is connected to the control system, a vacuum pump port of the refrigeration unit connected to a vacuum pump, a compressor configured to pump water from a water source to the refrigeration unit. The refrigeration unit is configured to cool the water to a cryogenic temperature and pump the water to the SMES device to cool the superconducting coil.

In an aspect, the control system is further configured to predict the DC current stored in the magnetic field based on:

$$i = \sqrt{\frac{P}{R}} \frac{1 + Π}{\sqrt{Π}} ,$$

where P is a predicted DC power input to the superconducting coil based on the predicted DC current and predicted voltage, R is an equivalent internal resistance of the superconducting coil, and Π is a transcendental equation defining the predicted DC current as a function of time given by:

$$Π = χ \cdot exp ( Π ) , ∀ χ > 0 ,$$

where χ is given by:

$$χ = \frac{R}{4 \cdot P} \cdot {e}^{( 1 + \frac{2 R}{L} ( t - {t}_{0} ) )} ,$$

where L is an equivalent inductance of the superconducting coil.

In an aspect, the control system is further configured to predict the DC current I_{L} in the superconducting coil and the voltage V_{L} across the superconducting coil during discharging to be given by:

$$i = \sqrt{\frac{P}{R}} \frac{1 + {trans}_{>} ( χ )}{{trans}_{>} ( χ )} , and$$

$${V}_{L} = \sqrt{\frac{P \cdot R}{{trans}_{>} ( χ )}} ,$$

where trans_{>}(χ) is given by:

$${trans}_{>} ( χ ) = t r a n {s}_{<} ( χ ) + log ( \frac{{F}_{u p}}{{F}_{low}} ) ,$$

where:

$${F}_{u p} = b \cdot {e}^{{b}_{1} \cdot ( U - α )} \cdot ( {R}_{α} - {e}^{- α \cdot {b}_{1}} {R}_{2 a} ) ,$$

$${F}_{low} = b \cdot {e}^{{b}_{1} , U} \cdot ( R - {e}^{- α \cdot {b}_{1}} {R}_{a} ) ,$$

$$R = {\sum }_{m = 0}^{[ U / α ]} {( - 1 )}^{m} {b}_{1}^{m} {e}^{- α \cdot {b}_{1} \cdot m} \frac{{( U - m \cdot α )}^{m}}{m !} ,$$

$${R}_{α} = {\sum }_{m = 0}^{[ {( U - α )}^{- α ]}} {( - 1 )}^{m} {b}_{1}^{m} {e}^{- a \cdot {b}_{1} \cdot m} \frac{{( U - α - m \cdot α )}^{m}}{m !} ,$$

$${R}_{2 a} = {\sum }_{m = 0}^{[ ( U - 2 α ) / α ]} {( - 1 )}^{m} {b}_{1}^{m} {e}^{- α \cdot {b}_{1} \cdot m} \frac{{( U - 2 α - m \cdot α )}^{m}}{m !} , and$$

$${trans}_{<} ( χ ) = log ( \frac{{\sum }_{n = 0}^{[ x - 1 ]} {( - 1 )}^{n} \frac{( x - 1 - n )}{n !} {χ}^{n}}{{\sum }_{n = 0}^{[ x ]} {( - 1 )}^{n} \frac{( x - n )}{n !} {χ}^{n}} )$$

where α=2 log(3), b=4/R, b₁=trans_{<}(x)/α and U is a positive integer.

In an aspect, the control system is further configured to predict the DC current I_{L} in the superconducting coil and the voltage V_{L} across the superconducting coil during charging to be given by:

$$i = \sqrt{\frac{{P}_{c}}{R}} \frac{{trans}_{L} ( δ ) - 1}{\sqrt{t r a n {s}_{L} ( δ )}} ,$$

$$and$$

$${V}_{L} = \sqrt{\frac{{P}_{c} \cdot R}{t r a n {s}_{L} ( δ )}} ,$$

where:

$$tran {s}_{L} ( δ ) = δ \frac{{\sum }_{n = 0}^{M} \frac{{{δ}^{n} ( M - n )}^{n}}{n !}}{{\sum }_{n = 0}^{M + 1} \frac{{{δ}^{n} ( M + 1 - n )}^{n}}{n !}}$$

where M is a positive integer and

$$δ = \frac{R}{4 \cdot {P}_{c}} \cdot {e}^{( 1 + \frac{2 R}{L} \cdot ( {t}_{0 c} + t ) )} .$$

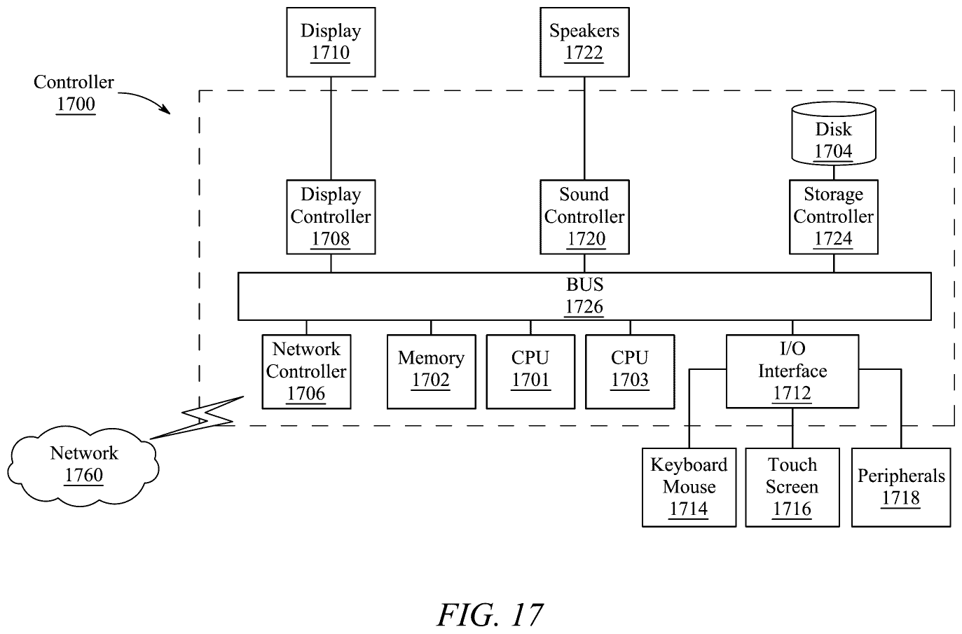

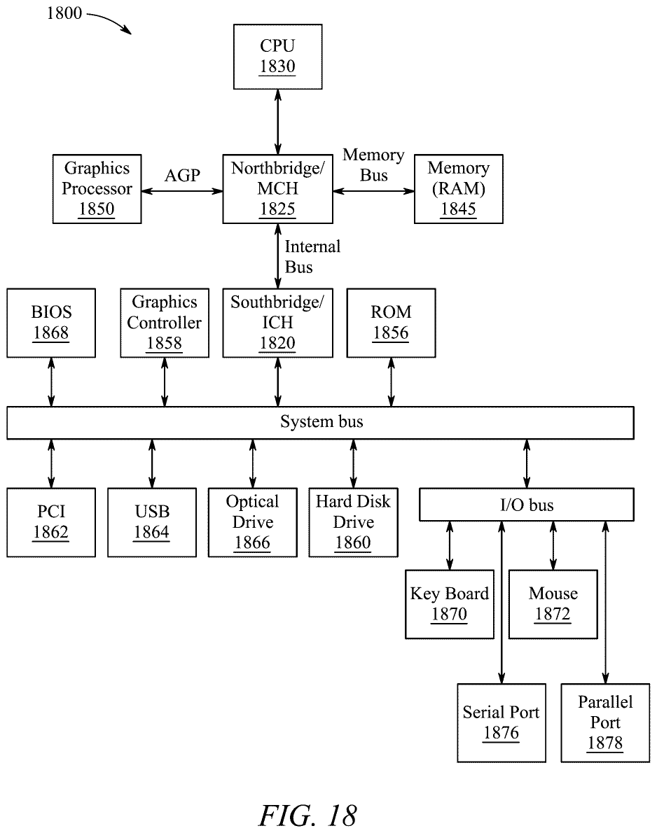

Next, further details of the hardware description of the computing environment according to exemplary embodiments is described with reference to FIG. 17. In FIG. 17, a controller 1700 is described as representative of the system 100 of FIG. 1A in which the controller 1700 represents the control system 110 which includes a CPU 1701 which performs the processes described above/below. The process data and instructions may be stored in memory 1702. These processes and instructions may also be stored on a storage medium disk 1704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1701, 1703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1701 or CPU 1703 may be a Xenon or Core processor from Intel of America or an Opteron processor from AMD of America, or may be other processor types that would be recognized by one of ordinary skill in the art. Alternatively, the CPU 1701, 1703 may be implemented on an FPGA, ASIC, PLD or using discrete logic circuits, as one of ordinary skill in the art would recognize. Further, CPU 1701, 1703 may be implemented as multiple processors cooperatively working in parallel to perform the instructions of the inventive processes described above.

The computing device in FIG. 17 also includes a network controller 1706, such as an Intel Ethernet PRO network interface card from Intel Corporation of America, for interfacing with network 1760. As can be appreciated, the network 1760 can be a public network, such as the Internet, or a private network such as an LAN or WAN network, or any combination thereof and can also include PSTN or ISDN sub-networks. The network 1760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1708, such as a NVIDIA GeForce GTX or Quadro graphics adaptor from NVIDIA Corporation of America for interfacing with display 1710, such as a Hewlett Packard HPL2445w LCD monitor. A general purpose I/O interface 1712 interfaces with a keyboard and/or mouse 1714 as well as a touch screen panel 1716 on or separate from display 1710. General purpose I/O interface also connects to a variety of peripherals 1718 including printers and scanners, such as an OfficeJet or DeskJet from Hewlett Packard.

A sound controller 1720 is also provided in the computing device such as Sound Blaster X-Fi Titanium from Creative, to interface with speakers/microphone 1722 thereby providing sounds and/or music.

The general purpose storage controller 1724 connects the storage medium disk 1704 with communication bus 1726, which may be an ISA, EISA, VESA, PCI, or similar, for interconnecting all of the components of the computing device. A description of the general features and functionality of the display 1710, keyboard and/or mouse 1714, as well as the display controller 1708, storage controller 1724, network controller 1706, sound controller 1720, and general purpose I/O interface 1712 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 18.

FIG. 18 shows a schematic diagram of a data processing system, according to certain embodiments, for performing the functions of the exemplary embodiments. The data processing system is an example of a computer in which code or instructions implementing the processes of the illustrative embodiments may be located.

In FIG. 18, data processing system 1800 employs a hub architecture including a north bridge and memory controller hub (NB/MCH) 1825 and a south bridge and input/output (I/O) controller hub (SB/ICH) 1820. The central processing unit (CPU) 1830 is connected to NB/MCH 1825. The NB/MCH 1825 also connects to the memory 1845 via a memory bus and connects to the graphics processor 1850 via an accelerated graphics port (AGP). The NB/MCH 1825 also connects to the SB/ICH 1820 via an internal bus (e.g., a unified media interface or a direct media interface). The CPU Processing unit 1830 may contain one or more processors and even may be implemented using one or more heterogeneous processor systems.

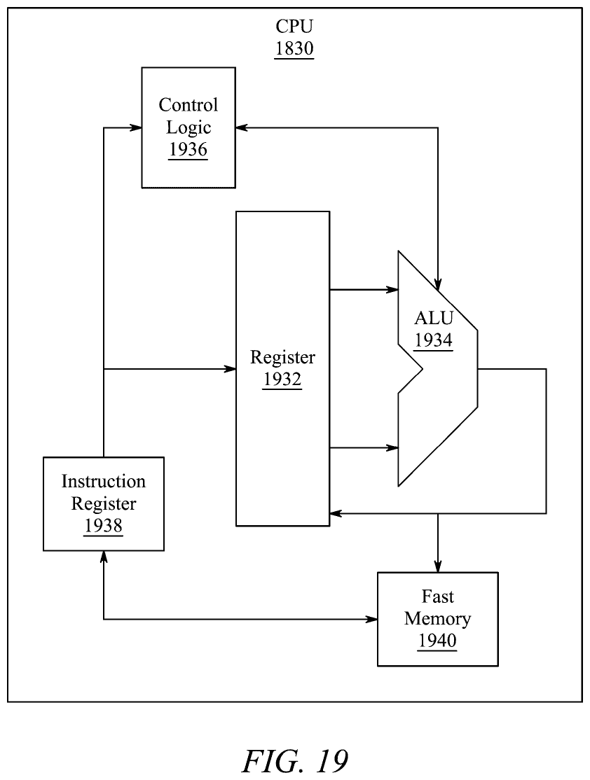

For example, FIG. 19 shows one implementation of CPU 1830. In one implementation, the instruction register 1938 retrieves instructions from the fast memory 1940. At least part of these instructions are fetched from the instruction register 1938 by the control logic 1936 and interpreted according to the instruction set architecture of the CPU 1830. Part of the instructions can also be directed to the register 1932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1934 that loads values from the register 1932 and performs logical and mathematical operations on the loaded values according to the instructions. The results from these operations can be feedback into the register and/or stored in the fast memory 1940. According to certain implementations, the instruction set architecture of the CPU 1830 can use a reduced instruction set architecture, a complex instruction set architecture, a vector processor architecture, a very large instruction word architecture. Furthermore, the CPU 1830 can be based on the Von Neuman model or the Harvard model. The CPU 1830 can be a digital signal processor, an FPGA, an ASIC, a PLA, a PLD, or a CPLD. Further, the CPU 1830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 18, the data processing system 1800 can include that the SB/ICH 1820 is coupled through a system bus to an I/O Bus, a read only memory (ROM) 1856, universal serial bus (USB) port 1864, a flash binary input/output system (BIOS) 1868, and a graphics controller 1858. PCI/PCIe devices can also be coupled to SB/ICH 1888 through a PCI bus 1862.

The PCI devices may include, for example, Ethernet adapters, add-in cards, and PC cards for notebook computers. The Hard disk drive 1860 and CD-ROM 1866 can use, for example, an integrated drive electronics (IDE) or serial advanced technology attachment (SATA) interface. In one implementation the I/O bus can include a super I/O (SIO) device.

Further, the hard disk drive (HDD) 1860 and optical drive 1866 can also be coupled to the SB/ICH 1820 through a system bus. In one implementation, a keyboard 1870, a mouse 1872, a parallel port 1878, and a serial port 1876 can be connected to the system bus through the I/O bus. Other peripherals and devices that can be connected to the SB/ICH 1820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

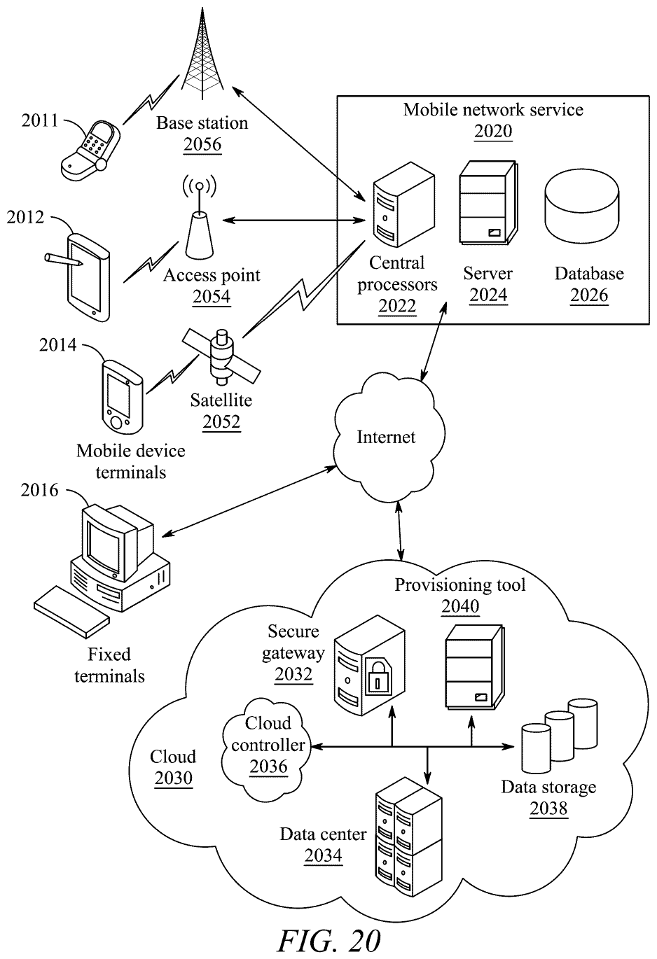

The functions and features described herein may also be executed by various distributed components of a system. For example, one or more processors may execute these system functions, wherein the processors are distributed across multiple components communicating in a network. The distributed components may include one or more client and server machines, such as cloud 2030 including a cloud controller 2036, a secure gateway 2032, a data center 2034, data storage 2038 and a provisioning tool 2040, and mobile network services 2020 including central processors 2022, a server 2024 and a database 2026, which may share processing, as shown by FIG. 20, in addition to various human interface and communication devices (e.g., display monitors 2016, smart phones 2010, tablets 2012, personal digital assistants (PDAs) 2014). The network may be a private network, such as a LAN, satellite 2052 or WAN 2054, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method for controlling charging and discharging of a superconducting magnetic energy storage (SMES) device, comprising:
connecting a three phase input terminal of a power conditioning system to a three phase power system, wherein the power conditioning system includes an AC/DC converter and a plurality of selectable switches;
connecting an input terminal and an output terminal of a superconducting coil of the SMES device to the power conditioning system;
receiving, by the SMES device, a DC current from the power conditioning system, wherein the SMES device includes a magnet surrounded by the superconducting coil, wherein the superconducting coil is configured to store the DC current in a magnetic field of the superconducting coil;
connecting a cryogenic refrigeration system to the SMES device;
connecting a control system to the power conditioning system, the cryogenic refrigeration system and the SMES device, wherein the control system includes a memory storing an equivalent circuit model of the SMES device and program instructions including a Perovich special trans function and Lambert's W equation, and at least one processor configured for executing the program instructions for:
deriving, by the control system, a set of transcendental equations for a voltage across the superconducting coil and the DC current stored in the magnetic field of the superconducting coil based on the equivalent circuit model; and
solving, by the at least one processor, the set of transcendental equations to predict a voltage V_{L} across the superconducting coil and the DC current I_{L} stored in the magnetic field of the superconducting coil using the Perovich special trans function theory and Lambert's W equation;
actuating, by the control system, the plurality of selectable switches based on the predicted voltage and the predicted DC current to perform one of:
charging the superconducting coil with the DC current and storing the DC current in the magnetic field of the superconducting coil; and
discharging the superconducting coil to generate a discharge DC current, converting the discharge DC current to AC power in the power conditioning system, and transmitting the AC power to the three phase power system.

2. The method of claim 1, further comprising:
predicting, by the control system, the DC current stored in the magnetic field based on:
$$i = \sqrt{\frac{P}{R}} \frac{1 + \prod }{\sqrt{\prod }} ,$$
where P is a predicted DC power input to the superconducting coil based on the predicted DC current and predicted voltage, R is an equivalent internal resistance of the superconducting coil and Π is a trancendental equation defining the predicted DC current as a function of time given by:
$$\prod = X \cdot exp ( \prod ) , ∀ X > 0 ,$$
where χ is given by:
$$X = \frac{R}{4 \cdot P} \cdot {e}^{( 1 + \frac{2 R}{L} ( t - {t}_{o} ) )} ,$$
and
where L is an equivalent inductance of the superconducting coil.

3. The method of claim 2, further comprising:
predicting, by the control system, the voltage V_{L} across the superconducting coil based on:
$${V}_{L} = \sqrt{\frac{P \cdot R}{\prod }} .$$

4. The method of claim 3, further comprising:
predicting, by the control system, the DC current I_{L} in the superconducting coil and the voltage V_{L} across the superconducting coil during discharging to be given by:
$$i = \sqrt{\frac{P}{R}} \frac{1 + {trans}_{>} ( X )}{\sqrt{{trans}_{>} ( X )}} , and$$
$${V}_{L} = \sqrt{\frac{P \cdot R}{{trans}_{>} ( X )}}$$
where trans_{>}(χ) is given by:
$${trans}_{>} ( X ) = {trans}_{<} ( X ) + log ( \frac{{F}_{up}}{{F}_{low}} ) ,$$
where:
$${F}_{up} = b \cdot {e}^{{b}_{1} \cdot ( U - α )} \cdot ( {R}_{α} - {e}^{- α \cdot {b}_{1}} {R}_{2 a} ) ,$$
$${F}_{low} = b \cdot {e}^{{b}_{1} , U} . ( R - {e}^{- α \cdot {b}_{1}} {R}_{a} ) ,$$
$$R = {\sum }_{m = 0}^{[ U / α ]} {( - 1 )}^{m} {b}_{1}^{m} {e}^{- α \cdot {b}_{1} \cdot m} \frac{{( U - m \cdot α )}^{m}}{m !} ,$$
$${R}_{α} = {\sum }_{m = 0}^{[ {( U - α )}^{- α ]}} {( - 1 )}^{m} {b}_{1}^{m} {e}^{- a \cdot {b}_{1} \cdot m} \frac{{( U - α - m \cdot α )}^{m}}{m !} ,$$
$${R}_{2 a} = {\sum }_{m = 0}^{[ ( U - 2 α ) / α ]} {( - 1 )}^{m} {b}_{1}^{m} {e}^{- a \cdot {b}_{1} \cdot m} \frac{{( U - 2 α - m \cdot α )}^{m}}{m !} , and$$
$${trans}_{>} ( X ) = log ( \frac{{\sum }_{n = 0}^{[ x - 1 ]} {( - 1 )}^{n} \frac{( x - 1 - n )}{n !} {X}^{n}}{{\sum }_{n = 0}^{[ x ]} {( - 1 )}^{n} \frac{( x - n )}{n !} {X}^{n}} )$$
where α=2 log(3), b=4/R, b₁=trans_{<}(x)/α and U is a positive integer.

5. The method of claim 4, further comprising:
predicting, by the control system, the DC current I_{L} in the superconducting coil and the voltage V_{L} across the superconducting coil during charging to be given by:
$$i = \sqrt{\frac{{P}_{c}}{R}} \frac{{trans}_{L} ( δ ) - 1}{\sqrt{{trans}_{L} ( δ )}} ,$$
$$and$$
$${V}_{L} = \sqrt{\frac{{P}_{c} \cdot R}{{trans}_{L} ( δ )}} ,$$
where:
$${trans}_{L} ( δ ) = δ \frac{{\sum }_{n = 0}^{M} \frac{{{δ}^{n} ( M - n )}^{n}}{n !}}{{\sum }_{n = 0}^{M + 1} \frac{{{δ}^{n} ( M + 1 - n )}^{n}}{n !}} ,$$
and
M is a positive integer and
$$δ = \frac{R}{4 \cdot {P}_{c}} \cdot {e}^{( 1 + \frac{2 R}{L} \cdot ( {t}_{0 c} + t ) )} .$$

6. The method of claim 1, wherein the equivalent circuit model of the SMES comprises a series connection of the DC power input to a resistor R representing an internal resistance of the superconducting coil and an inductor L representing the superconducting coil, having a DC current entering the resistor R and a voltage V_{L} across the inductor L.

7. The method of claim 1, wherein the equivalent circuit model of the SMES comprises a parallel connection of the DC power input, a resistor R representing an internal resistance of the superconducting coil and an inductor L representing the superconducting coil, having a DC current which exits the inductor L and a voltage V_{L} across the inductor L.

8. A system for controlling charge and discharge cycles of a superconducting magnetic energy storage (SMES) device, comprising:
a three phase power system;
a power conditioning system configured with a set of three phase input terminals, wherein the set of three phase input terminals are connected by a transformer to a set of three phase output terminals of the three phase power system;
a superconducting magnetic energy storage (SMES) device operatively connected to the power conditioning system, wherein the SMES device includes a superconducting coil;
a cryogenic refrigeration system operatively connected to the SMES device;
a control system connected to the power conditioning system, the cryogenic refrigeration system and the SMES, wherein the control system includes a memory storing an equivalent circuit model of the SMES and program instructions including a Perovich special trans function and Lambert's W equation, and at least one processor configured for executing the program instructions to:
derive a set of transcendental equations for a voltage across the superconducting coil and a DC current stored in the magnetic field of the superconducting coil based on the equivalent circuit model;
predict a voltage V_{L} across the superconducting coil and the DC current I_{L} stored in the magnetic field of the superconducting coil by solving the set of transcendental equations to using the Perovich special trans function theory and Lambert's W equation;
actuate the power conditioning system based on the predicted voltage and the predicted DC current to perform one of:
charge the superconducting coil with the DC current and storing the DC current in the magnetic field of the superconducting coil; and
discharge the superconducting coil to generate a discharge DC current, convert the discharge DC current to AC power in the power conditioning system, and transmit the AC power to the three phase power system.

9. The system of claim 8, wherein the equivalent circuit model of the SMES comprises a series connection of the DC power input to a resistor R representing an internal resistance of the superconducting coil and an inductor L representing the superconducting coil, a DC current entering the resistor R and the voltage V_{L} across the inductor L.

10. The system of claim 8, wherein the equivalent circuit model of the SMES comprises a parallel connection of the DC power input, a resistor R representing an internal resistance of the superconducting coil and an inductor L representing the superconducting coil, a DC current which exits the inductor L and a voltage V_{L} across the inductor L.

11. The system of claim 8, wherein the power conditioning system further includes:
an AC/DC converter including a voltage source converter comprising a plurality of selectable switches connected to the set of three phase input terminals and a capacitor connected parallel to the voltage source converter; and
a DC/DC converter connected parallel to the voltage source converter and the DC-link capacitor, wherein the DC/DC converter includes a set of DC output terminals configured to connect to the SMES device.

12. The system of claim 11, wherein the plurality of selectable switches includes three sets of series connected N-channel MOSFET transistors each having an antiparallel diode, wherein:
a first set includes a first N-channel MOSFET transistor T₁ₐ having a drain terminal connected to a positive bus line, a gate terminal G₁ₐ, and a source terminal and a second N-channel MOSFET transistor T₂ₐ having a drain terminal connected to the source terminal of the first N-channel MOSFET transistor T₁ₐ, a gate terminal G₂ₐ and a source terminal connected to a negative bus line, wherein the source terminal of the first N-channel MOSFET transistor T₁ₐ is connected to a first phase terminal Pₐ of the set of three phase input terminals,
a second set includes a first N-channel MOSFET transistor T_{1b} having a drain terminal connected to the positive bus line, a gate terminal G_{1b} and a source terminal and a second N-channel MOSFET transistor T_{2b} having a drain terminal connected to the source terminal of the first N-channel MOSFET transistor T_{1b}, a gate terminal G_{2b} and a source terminal connected to the negative bus line, wherein the source terminal of the first N-channel MOSFET transistor T_{1b} is connected to a second phase terminal P_{b} of the set of three phase input terminals, and
a third set includes a first N-channel MOSFET transistor T_{1c} having a drain terminal connected to the positive bus line, a gate terminal G_{1c}, and a source terminal and a second N-channel MOSFET transistor T_{2c} having a drain terminal connected to the source terminal of the first N-channel MOSFET transistor T_{1c}, a gate terminal G_{2c} and a source terminal connected to the negative bus line, wherein the source terminal of the first N-channel MOSFET transistor T_{1c} is connected to a third phase terminal P_{c} of the set of three phase input terminals.

13. The system of claim 12, wherein the DC-link capacitor has a first terminal connected to the positive bus line and a second terminal connected to the negative bus line.

14. The system of claim 13, wherein the DC/DC converter comprises:
an N-channel MOSFET transistor M₁ having a drain terminal connected to the positive bus line, a gate terminal G_{M1} and a source terminal connected to an input terminal of the superconducting coil of the SMES device;
a first reverse diode D₁ having an output terminal connected to the source terminal of the first N-channel MOSFET transistor M₁ and an input terminal connected to the negative bus line;
a second reverse diode D₂ having an output terminal to the positive bus line; and
an N-channel MOSFET transistor M₂ having a source terminal connected to the negative bus line, a gate terminal G_{M2} and a drain terminal connected to an output terminal of the superconducting coil of the SMES device.

15. The system of claim 14, wherein the power conditioning system further comprises:
a phase locked loop circuit;
an abc/dq converter operatively connected to the phase locked loop circuit;
a first transmission line meter connected to a set of three phase transmission lines of the three phase power system, wherein the first transmission line meter is located on the set of three transmission lines between the three phase power system and the transformer, wherein the first transmission line meter is configured to measure a voltage of each of the three phase transmission lines and transmit the measured voltages to the phase locked loop, wherein the phase locked loop is configured to generate a phase error of the measured voltages with respect to a reference phase angle;
a second transmission line meter connected to the three phase transmission lines located on the set of three transmission lines between the transformer and the power conditioning system, wherein the second transmission line meter is configured to measure a current on each of the three phase transmission lines and a voltage on each of the three phase transmission lines and transmit the measured currents to the abc/dq converter;
a dq/abc converter operatively connected to an output terminal of the phase locked loop circuit, wherein the dq/abc converter is configured to receive the phase error;
a first control circuit configured to receive the predicted voltage V_{L} from the control system, generate a voltage error signal between a DC value of the predicted voltage V_{L} and a DC value of the measured voltage from the first transmission line meter, convert the voltage error signal to a direct current reference signal, receive a direct current signal from the abc/dq converter and generate a direct current error signal by subtracting the direct current reference signal from the direct current reference signal;
a second control circuit configured to receive the direct current error signal and convert the direct current error signal to a quadrature voltage reference signal and transmit the quadrature voltage reference signal to the dq/abc converter;
a third control circuit configured to receive the predicted voltage V_{L} from the control system, generate a voltage error signal between an AC value of the predicted voltage V_{L} and an AC value of the measured voltage from the second transmission line meter, convert the voltage error signal to a quadrature current reference signal, receive a quadrature current signal from the abc/dq converter and generate a quadrature current error signal by subtracting the quadrature current reference signal from the quadrature current reference signal;
a fourth control circuit configured to receive the quadrature current error signal and convert the quadrature current error signal to a direct voltage reference signal and transmit the direct voltage reference signal to the dq/abc converter;
wherein the dq/abc converter is configured to receive the quadrature voltage reference signal and the direct voltage reference signal, correct the phase error of the quadrature voltage reference signal and the direct voltage reference signal and generate a corrected three phase voltage signal; and
a pulse width modulator operatively connected to the dq/abc converter, wherein the pulse width modulator is configured to generate drive signals and transmit the drive signals to the voltage source converter to control the gate terminals G₁ₐ, G₂ₐ, G_{1b}, G_{2b}, G₃ₐ and G_{3b} of the plurality of selectable switches based on the corrected three phase voltage signal.

16. The system of claim 15, wherein the power conditioning system further comprises:
a fifth control circuit configured to receive, from the DC/DC converter, the power P_{L} generated by DC current and the voltage V_{L} across the superconducting coil, generate a power error by subtracting the power P_{L} from a reference power P_{L-ref}, convert the power error to a duty cycle error ΔD, limit the duty cycle error between an upper bound of 0.5 and a lower bound of −0.5, multiply the limited duty cycle error by 0.5 and generate a set of duty cycle control signals and transmit the duty cycle control signals to the gate terminals G_{M1} and G_{M2} of the DC/DC converter to control a charge cycle and a discharge cycle of the superconducting coil of the SMES device.

17. The system of claim 8, wherein the cryogenic refrigeration system includes:
a refrigeration unit;
a DC power supply terminal of the refrigeration unit connected to a DC power supply;
a terminal block input terminal of the refrigeration unit connected to a terminal block;
a temperature monitor connected to the terminal block, wherein the temperature monitor is connected to the control system;
a vacuum pump port of the refrigeration unit connected to a vacuum pump;
a compressor configured to pump water from a water source to the refrigeration unit,
wherein the refrigeration unit is configured to cool the water to a cryogenic temperature and pump the water to the SMES device to cool the superconducting coil.

18. The system of claim 8, wherein the control system is further configured to predict the DC current stored in the magnetic field based on:
$$i = \sqrt{\frac{P}{R}} \frac{1 + \prod }{\sqrt{\prod }} ,$$
where P is a predicted DC power input to the superconducting coil based on the predicted DC current and predicted voltage, R is an equivalent internal resistance of the superconducting coil and Π is a trancendental equation defining the predicted DC current as a function of time given by:
$$\prod = χ \cdot exp ( \prod ) , ∀ χ > 0 ,$$
where χ is given by:
$$χ = \frac{R}{4 \cdot P} \cdot {e}^{( 1 + \frac{2 R}{L} ( t - {t}_{0} ) )} ,$$
where L is an equivalent inductance of the superconducting coil.

19. The system of claim 18, wherein the control system is further configured to predict the DC current I_{L} in the superconducting coil and the voltage V_{L} across the superconducting coil during discharging to be given by:
$$i = \sqrt{\frac{P}{R}} \frac{1 + {trans}_{>} ( χ )}{\sqrt{{trans}_{>} ( χ )}} , and$$
$${V}_{L} = \sqrt{\frac{P \cdot R}{{trans}_{>} ( χ )}} ,$$
where trans_{>}(χ) is given by:
$${trans}_{>} ( χ ) = {trans}_{>} ( χ ) + log ( \frac{{F}_{up}}{{F}_{low}} ) ,$$
where:
$${F}_{up} = b \cdot {e}^{{b}_{1} \cdot ( U - α )} \cdot ( {R}_{α} - {e}^{- α \cdot {b}_{1}} {R}_{2 a} ) ,$$
$${F}_{low} = b \cdot {e}^{{b}_{1} , U} \cdot ( R - {e}^{- α \cdot {b}_{1}} {R}_{a} ) ,$$
$$R = {\sum }_{m = 0}^{[ U / α ]} {( - 1 )}^{m} {b}_{1}^{m} {e}^{- α \cdot {b}_{1} \cdot m} \frac{{( U - m \cdot α )}^{m}}{m !} ,$$
$${R}_{α} = {\sum }_{m = 0}^{[ {( U - α )}^{- α ]}} {( - 1 )}^{m} {b}_{1}^{m} {e}^{- a \cdot {b}_{1} \cdot m} \frac{{( U - α - m \cdot α )}^{m}}{m !} ,$$
$${R}_{2 a} = {\sum }_{m = 0}^{[ ( U - 2 α ) / α ]} {( - 1 )}^{m} {b}_{1}^{m} {e}^{- α \cdot {b}_{1} \cdot m} \frac{{( U - 2 α - m \cdot α )}^{m}}{m !} , and$$
$${trans}_{<} ( χ ) = log ( \frac{{\sum }_{n = 0}^{[ x - 1 ]} {( - 1 )}^{n} \frac{( x - 1 - n )}{n !} {χ}^{n}}{{\sum }_{n = 0}^{[ x ]} {( - 1 )}^{n} \frac{( x - n )}{n !} {χ}^{n}} )$$
where α=2 log(3), b=4/R, b₁=trans_{<}(x)/α and U is a positive integer.

20. The system of claim 19, wherein the control system is further configured to predict the DC current I_{L} in the superconducting coil and the voltage V_{L} across the superconducting coil during charging to be given by:
$$i = \sqrt{\frac{{P}_{c}}{R}} \frac{{trans}_{L} ( δ ) - 1}{\sqrt{{trans}_{L} ( δ )}} ,$$
$$and$$
$${V}_{L} = \sqrt{\frac{{P}_{c} \cdot R}{{trans}_{L} ( δ )}} ,$$
where:
$${trans}_{L} ( δ ) = δ \frac{{\sum }_{n = 0}^{M} \frac{{{δ}^{n} ( M - n )}^{n}}{n !}}{{\sum }_{n = 0}^{M + 1} \frac{{( M + 1 - n )}^{n}}{n !}}$$
where M is a positive integer and
$$δ = \frac{R}{4 \cdot {P}_{c}} \cdot {e}^{( 1 + \frac{2 R}{L} \cdot ( {t}_{0 c} + t ) )} .$$
